(19) United States
(12) Patent Application Publication
(10) Pub. No.: US 2025/0227540 A1
(43) Pub. Date: Jul. 10, 2025

(54) INFORMATION PROCESSING METHOD AND COMMUNICATION DEVICE

(71) Applicant: VIVO MOBILE COMMUNICATION CO., LTD., Dongguan (CN)

(72) Inventor: Xiaowan KE, Dongguan (CN)

(21) Appl. No.: 19/093,322

(22) Filed: Mar. 28, 2025

Related U.S. Application Data
(63) Continuation of application No. PCT/CN2023/123157, filed on Oct. 7, 2023.

(30) Foreign Application Priority Data
Sep. 29, 2022 (CN) 202211204895.1
Nov. 11, 2022 (CN) 202211414775.4

(51) Int. Cl. H04W 28/02; H04L 47/32; H04W 28/06

(52) U.S. Cl. CPC H04W 28/0236; H04L 47/32; H04W 28/06

(57) ABSTRACT

Embodiments of this application provide an information processing method and a communication device, and an information processing method applied to a first communication device includes: obtaining, by the first communication device, first information, where the first information includes at least one of the following: a PDU set delay budget (PSDB), a packet delay budget (PDB), an access network (AN) PSDB, an access network (AN) PDB, first duration, second duration, first interval duration, a first time, a second time, or first duration of a first timer; and performing, by the first communication device, a first operation based on the first information.

### CROSS-REFERENCE TO RELATED APPLICATIONS

This application is a continuation of International Patent Application No. PCT/CN2023/123157, filed on Oct. 7, 2023, which claims priority to Chinese Patent Application No. 202211204895.1, filed on Sep. 29, 2022, and this application further claims priority to Chinese Patent Application No. 202211414775.4, filed on Nov. 11, 2022, which is incorporated herein by reference in their entireties.

### TECHNICAL FIELD

Embodiments of this application relate to the field of wireless communication technologies, and in particular, to an information processing method and a communication device.

### BACKGROUND

A PDU Set Delay Budget (PSDB) is different from a Packet Delay Budget (PDB). The PDB is a delay budget for a single packet (Protocol Data Unit, PDU), and the PSDB is a delay budget for a set of packets, that is, a time from transmission of the 1st packet in a packet set (PDU Set) to that of the last packet cannot exceed the PSDB.

### SUMMARY

To resolve the foregoing technical problem, this application is implemented as follows:

According to a first aspect, an embodiment of this application provides an information processing method, including:
obtaining, by a first communication device, first information, where the first information includes at least one of the following: a PDU set delay budget (PSDB), a packet delay budget (PDB), an access network (AN) PSDB, an access network (AN) PDB, first duration, second duration, first interval duration, a first time, a second time, or first duration of a first timer; and
performing, by the first communication device, a first operation based on the first information;
where the first operation includes at least one of the following:
determining a delay budget of a first packet set;
determining duration of a first object;
modifying remaining duration of the delay budget of the first packet set, extending remaining duration of the delay budget of the first packet set, and/or restarting timing of the delay budget of the first packet set;
modifying remaining duration of the first object, extending remaining duration of the first object, and/or restarting timing of the first object;
stopping timing of the delay budget of the first packet set;
stopping timing of the first object;
applying, to a first packet, QoS, a delay, a timer, and/or an operation per packet set;
applying, to a second packet, QoS, a delay, a timer, and/or an operation per packet; or setting a second access network delay budget or duration of a second timer of a third packet;
where
the first packet, the second packet, or the third packet is one or more packets in the first packet set;
the first object includes one of the following: a first timer of the first data set or an access network delay budget of the first data set, where the first timer is a discard timer used per packet set;
the second timer is a discard timer used per packet;
the first time is an arrival time of the 1st packet in the first packet set;
the second time is an arrival time of the last packet in the first packet set; and
the first interval duration is interval duration between the arrival time of the last packet in the first packet set and the arrival time of the 1st packet in the first packet set.

According to a second aspect, an embodiment of this application provides an information processing method, including:
obtaining, by a second communication device, second information, where the second information includes at least one of the following: a PDB, an AN PDB, first duration, second duration, or first duration of a first timer; and
performing, by the second communication device, a second operation based on the second information, where the second operation includes at least one of the following:
determining a delay budget of a first packet set or duration of the first timer;
determining duration of a first object;
restarting timing of the delay budget of the first packet set;
restarting timing of the first object; or
setting a second access network delay budget or duration of a second timer of a third packet;
where
the third packet is one or more packets in the first packet set;
the first object includes one of the following: a first timer of the first data set or a first access network delay budget of the first data set;
the first timer is a discard timer used per packet set; and
the second timer is a discard timer used per packet.

According to a third aspect, an embodiment of this application provides an information processing method, including:
obtaining, by a third communication device, third information, where the third information includes at least one of the following: a first PSDB, a first AN PSDB, first duration of a first timer, first duration of a second timer, a PDB, an AN PDB, first duration, second duration, a first indication, or a second indication; and
performing, by the third communication device, a third operation based on the third information, where the third operation includes at least one of the following:
setting initial duration of a delay budget of a first packet set to one of the following: an infinite value or a first value;
setting initial duration of a first object to one of the following: an infinite value or a second value;
modifying remaining duration of the delay budget of the first packet set, and/or restarting timing of the delay budget of the first packet set;
modifying remaining duration of the first object, and/or restarting timing of the first object;
stopping timing of the delay budget of the first packet set;
stopping timing of the first object; or
setting a second access network delay budget or duration of a second timer of a third packet;
where
the first PSDB is used to indicate an infinite value or the first value;
the first AN PSDB or the first duration of the first timer is used to indicate an infinite value or the second value;
the first value or the second value meets the following condition: being long enough for the third communication device to determine that the last packet in the first packet set is lost, or being long enough for the third communication device to receive the last packet in the first packet set;
the third packet is one or more packets in the first packet set;
the first object includes one of the following: a first timer of the first data set or an access network delay budget of the first data set;
the first timer is a discard timer used per packet set; and
the second timer is a discard timer used per packet;
where
the first object includes one of the following: the first timer of the first data set, the access network delay budget of the first data set, the AN PSDB, or the first timer;
where
the first indication is used to indicate at least one of the following:
an initial value of the PSDB or the delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify the remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

According to a fourth aspect, an embodiment of this application provides an information processing method, including:
sending, by a fourth communication device, at least one of the following:
a first PSDB or a PSDB, a first AN PSDB or an AN PSDB, a PDB, first duration, an AN PDB, second duration, an initial PSDB, first interval duration, a first time, a second time, first duration of a first timer, first duration of a second timer, a first indication, or a second indication;
where
the first time is an arrival time of the 1st packet in a first packet set;
the second time is an arrival time of the last packet in the first packet set, or a time at which the last packet in the first packet set is determined to be lost; and
the first interval duration is interval duration between the arrival time of the last packet in the first packet set and the arrival time of the 1st packet in the first packet set;
where
the first PSDB is used to indicate an infinite value or a first value;
the first AN PSDB or the first duration of the first timer is used to indicate an infinite value or a second value;
the first value or the second value meets the following condition: being long enough for a third communication device to determine that the last packet in the first packet set is lost, or being long enough for a third communication device to receive the last packet in the first packet set;
the first timer is a discard timer used per packet set; and
the second timer is a discard timer used per packet;
where
a first object includes one of the following: a first timer of the first data set, an access network delay budget of the first data set, the AN PSDB, or the first timer;
where
the first indication is used to indicate at least one of the following:
an initial value of the PSDB or a delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

According to a fifth aspect, an embodiment of this application provides an information processing apparatus, applied to a first communication device and including:
a first obtaining module, configured to obtain first information, where the first information includes at least one of the following: a PDU set delay budget (PSDB), a packet delay budget (PDB), an access network (AN) PSDB, an access network (AN) PDB, first duration, second duration, first interval duration, a first time, a second time, or first duration of a first timer; and
a first processing module, configured to perform a first operation based on the first information;
where the first operation includes at least one of the following:
determining a delay budget of a first packet set;
determining duration of a first object;
modifying remaining duration of the delay budget of the first packet set, extending remaining duration of the delay budget of the first packet set, or restarting timing of the delay budget of the first packet set;
modifying remaining duration of the first object, extending remaining duration of the first object, or restarting timing of the first object;
stopping timing of the delay budget of the first packet set;
stopping timing of the first object;
applying, to a first packet, QoS, a delay, a timer, and/or an operation per packet set;
applying, to a second packet, QoS, a delay, a timer, and/or an operation per packet; or
setting a second access network delay budget or duration of a second timer of a third packet;
where
the first packet, the second packet, or the third packet is one or more packets in the first packet set;
the first object includes one of the following: a first timer of the first data set or an access network delay budget of the first data set, where the first timer is a discard timer used per packet set;
the second timer is a discard timer used per packet;
the first time is an arrival time of the 1st packet in the first packet set;
the second time is an arrival time of the last packet in the first packet set; and
the first interval duration is interval duration between the arrival time of the last packet in the first packet set and the arrival time of the 1st packet in the first packet set.

According to a sixth aspect, an embodiment of this application provides an information processing apparatus, applied to a second communication device and including:
a second obtaining module, configured to obtain second information, where the second information includes at least one of the following: a PDB, an AN PDB, first duration, second duration, or first duration of a first timer; and
a second processing module, configured to perform a second operation based on the second information, where the second operation includes at least one of the following:
determining a delay budget of a first packet set or duration of the first timer;
determining duration of a first object;
restarting timing of the delay budget of the first packet set;
restarting timing of the first object; or
setting a second access network delay budget or duration of a second timer of a third packet;
where
the third packet is one or more packets in the first packet set;
the first object includes one of the following: a first timer of the first data set or a first access network delay budget of the first data set;
the first timer is a discard timer used per packet set; and
the second timer is a discard timer used per packet.

According to a seventh aspect, an embodiment of this application provides an information processing apparatus, applied to a third communication device and including:
a third obtaining module, configured to obtain third information, where the third information includes at least one of the following: a first PSDB, a first AN PSDB, first duration of a first timer, first duration of a second timer, a PDB, an AN PDB, first duration, second duration, a first indication, or a second indication; and
a third processing module, configured to perform a third operation based on the third information, where the third operation includes at least one of the following:
setting initial duration of a delay budget of a first packet set to one of the following: an infinite value or a first value;
setting initial duration of a first object to one of the following: an infinite value or a second value;
modifying remaining duration of the delay budget of the first packet set, and/or restarting timing of the delay budget of the first packet set;
modifying remaining duration of the first object, and/or restarting timing of the first object;
stopping timing of the delay budget of the first packet set;
stopping timing of the first object; or
setting a second access network delay budget or duration of a second timer of a third packet;
where
the first PSDB is used to indicate an infinite value or the first value;
the first AN PSDB or the first duration of the first timer is used to indicate an infinite value or the second value;
the first value or the second value meets the following condition: being long enough for the third communication device to determine that the last packet in the first packet set is lost, or being long enough for the third communication device to receive the last packet in the first packet set;
the third packet is one or more packets in the first packet set;
the first object includes one of the following: a first timer of the first data set or an access network delay budget of the first data set;
the first timer is a discard timer used per packet set; and
the second timer is a discard timer used per packet;
where
the first object includes one of the following: the first timer of the first data set, the access network delay budget of the first data set, the AN PSDB, or the first timer;
where
the first indication is used to indicate at least one of the following:
an initial value of the PSDB or the delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify the remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

According to an eighth aspect, an embodiment of this application provides an information processing apparatus, applied to a fourth communication device and including:
a sending module, configured to send at least one of the following:
a first PSDB or a PSDB, a first AN PSDB or an AN PSDB, a PDB, first duration, an AN PDB, second duration, an initial PSDB, first interval duration, a first time, a second time, first duration of a first timer, first duration of a second timer, a first indication, or a second indication;
where
the first time is an arrival time of the 1st packet in a first packet set;
the second time is an arrival time of the last packet in the first packet set, or a time at which the last packet in the first packet set is determined to be lost; and
the first interval duration is interval duration between the arrival time of the last packet in the first packet set and the arrival time of the 1st packet in the first packet set;
where
the first PSDB is used to indicate an infinite value or a first value;
the first AN PSDB or the first duration of the first timer is used to indicate an infinite value or a second value;
the first value or the second value meets the following condition: being long enough for a third communication device to determine that the last packet in the first packet set is lost, or being long enough for a third communication device to receive the last packet in the first packet set;
the first timer is a discard timer used per packet set; and
the second timer is a discard timer used per packet;
where
a first object includes one of the following: a first timer of the first data set, an access network delay budget of the first data set, the AN PSDB, or the first timer;
where
the first indication is used to indicate at least one of the following:
an initial value of the PSDB or a delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

According to a ninth aspect, a communication device is provided. The communication device includes a processor and a memory. The memory stores a program or instructions capable of running on the processor, and the program or the instructions is or are executed by the processor to implement the steps of the method according to the first aspect, the second aspect, the third aspect, or the fourth aspect.

According to a tenth aspect, a communication device is provided, including a processor and a communication interface. The processor is configured to implement the steps of the method according to the first aspect, or implement the steps of the method according to the second aspect, or implement the steps of the method according to the third aspect, or implement the steps of the method according to the fourth aspect.

According to an eleventh aspect, an information processing system is provided, including a first communication device, a second communication device, a third communication device, and a fourth communication device. The first communication device may be configured to perform the steps of the method according to the first aspect, the second communication device may be configured to perform the steps of the method according to the second aspect, the third communication device may be configured to perform the steps of the method according to the third aspect, and the fourth communication device may be configured to perform the steps of the method according to the fourth aspect.

According to a twelfth aspect, a readable storage medium is provided. The readable storage medium stores a program or instructions, and the program or the instructions is or are executed by a processor to implement the steps of the method according to the first aspect, or implement the steps of the method according to the second aspect, or implement the steps of the method according to the third aspect, or implement the steps of the method according to the fourth aspect.

According to a thirteenth aspect, a chip is provided. The chip includes a processor and a communication interface, the communication interface is coupled to the processor, and the processor is configured to run a program or instructions to implement the method according to the first aspect, or implement the method according to the second aspect, or implement the method according to the third aspect, or implement the method according to the fourth aspect.

According to a fourteenth aspect, a computer program/program product is provided. The computer program/program product is stored in a storage medium, and the computer program/program product is executed by at least one processor to implement the steps of the method according to the first aspect, or implement the steps of the method according to the second aspect, or implement the steps of the method according to the third aspect, or implement the steps of the method according to the fourth aspect.

### BRIEF DESCRIPTION OF DRAWINGS

Other advantages and benefits will become clear to a person of ordinary skill in the art by reading the following detailed description of the preferred implementations. The accompanying drawings are merely intended to illustrate the purpose of the preferred implementations, but are not intended to limit this application. In addition, throughout the accompanying drawings, a same reference numeral is used to represent a same component. In the accompanying drawings:

FIG. 1 is a schematic diagram of an architecture of a communication system according to an embodiment of this application;

FIG. 2 is a flowchart of an information processing method according to an embodiment of this application;

FIG. 3 is a flowchart of another information processing method according to an embodiment of this application;

FIG. 4 is a flowchart of another information processing method according to an embodiment of this application;

FIG. 5 is a flowchart of another information processing method according to an embodiment of this application;

FIG. 6 is a schematic diagram of a scenario 1 according to an embodiment of this application;

FIG. 7 is a schematic diagram of a scenario 2 according to an embodiment of this application;

FIG. 8 is a schematic diagram of a scenario 3 according to an embodiment of this application;

FIG. 9 is a schematic diagram of a scenario 4 according to an embodiment of this application;

FIG. 10 is a schematic diagram of a scenario 5 according to an embodiment of this application;

FIG. 11 is a schematic diagram of a scenario 6 according to an embodiment of this application;

FIG. 12 is a schematic diagram of a scenario 7 according to an embodiment of this application;

FIG. 13 is a schematic diagram of a scenario 8 according to an embodiment of this application;

FIG. 14 is a schematic diagram of a scenario 9 according to an embodiment of this application;

FIG. 15 is a schematic diagram of a scenario 10 according to an embodiment of this application;

FIG. 16 is a structural diagram of an information processing apparatus according to this application;

FIG. 17 is a structural diagram of another information processing apparatus according to this application;

FIG. 18 is a structural diagram of another information processing apparatus according to this application;

FIG. 19 is a structural diagram of another information processing apparatus according to this application; and

FIG. 20 is a structural diagram of a communication device according to this application.

### DESCRIPTION OF EMBODIMENTS

The following clearly describes the technical solutions in embodiments of this application with reference to the accompanying drawings in the embodiments of this application. It is clear that the described embodiments are some rather than all the embodiments of this application. All other embodiments obtained by a person of ordinary skill in the art based on the embodiments of this application without creative efforts shall fall within the protection scope of this application.

The terms “first”, “second”, and the like in this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in this application, “and/or” represents at least one of connected objects, and the character “/” generally represents an “or” relationship between associated objects.

The term “include” in this application and any variation thereof are intended to cover non-exclusive inclusion. For example, a process, a method, a system, a product, or a device that include a series of steps or units is not limited to those steps or units that are expressly listed, but may include other steps or units that are not expressly listed or that are inherent to such a process, method, product, or device. In addition, in this application, “and/or” are used to indicate at least one of connected objects. For example, A and/or B represents the following three cases: Only A exists, only B exists, and both A and B exist.

In the embodiments of this application, words such as “example” or “for example” are used to indicate an example, illustration, or description. Any embodiment or design solution described as “example” or “for example” in the embodiments of this application should not be construed as being more preferred or advantageous than other embodiments or design solutions. Exactly, the words such as “example” or “for example” are used to present related concepts in a specific manner.

Technologies described herein are not limited to a 5th-generation (5G) system and a subsequent evolved communication system and are not limited to a Long Term Evolution (LTE)/LTE-Advanced (LTE-A) system, and may also be used in various wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and another system.

In the embodiments of this application, the terms “system” and “network” are usually used interchangeably. The technologies described may be used for the systems and radio technologies mentioned above, as well as other systems and radio technologies. A New Radio (NR) system is described in the following descriptions for illustrative purposes, and NR terms are used in most of the following descriptions. However, these technologies can also be applied to applications such as a 6th Generation (6G) communication system other than NR system applications. The CDMA system can implement radio technologies such as CDMA2000 and Universal Terrestrial Radio Access (UTRA). UTRA includes Wideband Code Division Multiple Access (WCDMA) and another CDMA variant. The TDMA system can implement radio technologies such as a Global System for Mobile Communication (GSM). The OFDMA system can implement radio technologies such as Ultra Mobile Broadband (UMB), Evolution-UTRA (E-UTRA), IEEE 802.11 (Wi-Fi), IEEE 802.16 (WiMAX), IEEE 802.20, and Flash-OFDM. UTRA and E-UTRA are parts of a Universal Mobile Telecommunications System (UMTS). LTE and more advanced LTE (for example, LTE-A) are new UMTS versions using E-UTRA. UTRA, E-UTRA, UMTS, LTE, LTE-A, and GSM are described in documents from an organization called 3rd Generation Partnership Project (3GPP). CDMA2000 and UMB are described in documents from an organization called “3rd generation partnership project 2” (3GPP2). The technologies described in this specification may be used for the systems and radio technologies mentioned above, as well as other systems and radio technologies.

To facilitate better understanding of the embodiments of this application, the following technical points are first described below.

After a fixed PSDB is set, timing of the PSDB does not start until the last packet arrives.

In the embodiments of this application, the following problems need to be resolved:
Problem 1: Currently, a discard timer of each PDU is mandatory. After the 1st PDU in a PDU set arrives at a Radio Access Network (RAN) network element, the RAN network element starts to set a discard timer of the PDU based on the PSDB. When an interval between an arrival time of the last PDU and that of the 1st PDU is very long, it is not clear how to set a discard timer of a PDU that previously arrives.
Problem 2: If the last PDU is lost, timing of the PSDB never starts. This is also not proper.

Currently, a fixed PSDB is usually set, and timing is performed from a first start time point (an arrival time point of the 1st packet in the packet set). However, if a jitter occurs in an arrival time of the last packet in the PDU set, a delay budget of the last packet is less than one PDB. In addition, in a more extreme case, some packets arrive only after the PSDB times out.

Embodiments of this application provide an information processing method and a communication device, to resolve a problem of how to ensure performance of a PDU set delay budget.

In the embodiments of this application, the first communication device obtains at least one of the PSDB, the PDB, the AN PSDB, the AN PDB, the first duration, the second duration, the first interval duration, the first time, the second time, or the first duration of the first timer, and then performs an operation based on the obtained information to ensure performance of a PDU set delay budget.

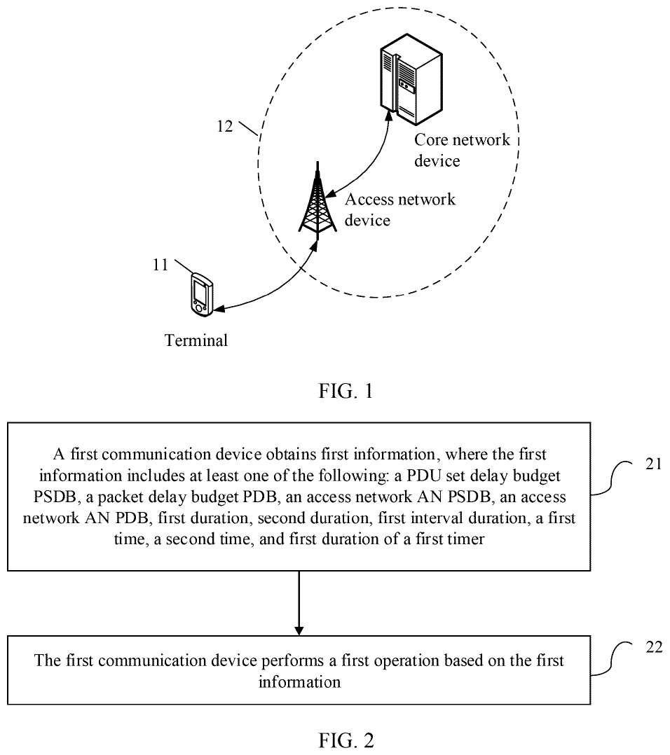

FIG. 1 is a block diagram of a wireless communication system applicable to an embodiment of this application. The wireless communication system includes a terminal 11 and a network-side device 12. The terminal 11 may be a mobile phone, a Tablet Personal Computer, a Laptop Computer or referred to as a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a Wearable Device, Vehicle User Equipment (VUE), Pedestrian User Equipment (PUE), a smart home (a home device with a wireless communication function, such as a refrigerator, a television, a laundry machine, or a furniture), a gaming console, a personal computer (PC), a teller machine, a self-service machine, or another terminal-side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network-side device 12 may include an access network device or a core network device. The access network device may also be referred to as a wireless access network device, a Radio Access Network (RAN), a radio access network function, or a radio access network unit. The access network device may include a base station, a Wireless Local Area Networks (WLAN) access point, a WiFi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. Provided that same technical effects are achieved, the base station is not limited to a specific technical term. It should be noted that in the embodiments of this application, only a base station in an NR system is used as an example for description, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF) unit, an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that in the embodiments of this application, only a core network device in the NR system is used as an example for description, and a specific type of the core network device is not limited.

Optionally, the obtaining may be understood as obtaining from a configuration, receiving, receiving by using a request, obtaining by means of self-learning, obtaining by means of derivation according to information not received, or obtaining by means of processing according to received information, which may be specifically determined according to an actual requirement, which is not limited in this embodiment of this application. For example, when a piece of capability indication information sent by a device is not received, it may be deduced that the device does not support the capability.

Optionally, sending may include broadcasting, broadcasting in a system message, and returning after a response is made to a request.

Optionally, a receiving time and an arrival time have a same meaning. For example, a receiving time of a packet and an arrival time of the packet may have a same meaning.

In an optional embodiment of this application, a communication device may include at least one of the following: a communication network element or a terminal.

In an embodiment of this application, the communication network element may include at least one of the following: a core network network element or a radio access network network element.

In this embodiment of this application, the Core Network (CN) network element may include but is not limited to at least one of the following: a core network device, a core network node, a core network function, a core network network element, a Mobility Management Entity (MME), an access mobility management function (Access Management Function, AMF), a Session Management Function (SMF), a User Plane Function (UPF), a serving GateWay (SGW), a PDN GateWay, a Policy Control Function (PCF), a Policy and Charging Rules Function (PCRF), a Serving GPRS Support Node (SGSN), a Gateway GPRS Support Node (GGSN), or an Application Function.

In this embodiment of this application, the RAN network element may include but is not limited to at least one of the following: a radio access network device, a radio access network node, a radio access network function, a radio access network unit, a 3GPP radio access network, a non-3GPP radio access network, a Centralized Unit (CU), a Distributed Unit (DU), a base station, an evolved NodeB (eNB), a 5G base station (gNB), a Radio Network Controller (RNC), a NodeB, a Non-3GPP InterWorking Function (N3IWF), an Access Controller (AC) node, an Access Point (AP) device, a Wireless Local Area Networks (WLAN) node, or the N3IWF.

The base station may be a base station (Base Transceiver Station, BTS) in GSM or CDMA, or may be a base station (NodeB) in WCDMA, or may be an evolved NodeB (eNB or e-NodeB, evolutional NodeB) in LTE or a 5G base station (gNB). This is not limited in the embodiments of this application.

In an optional embodiment of this application, a UE may include one of the following: a terminal device, a terminal device and a card, or a card.

In an optional embodiment of this application, the card may include one of the following: a subscriber identity module card (Subscriber Identity Module, SIM card), a Universal Subscriber Identity Module (USIM) card, or an Embedded-SIM (eSIM).

In an optional embodiment of this application, the terminal may include a relay that supports a terminal function and/or a terminal that supports a relay function. The terminal may also be referred to as a terminal device or User Equipment (UE). The terminal may be a terminal-side device such as a mobile phone, a Tablet Personal Computer, a Laptop Computer, a Personal Digital Assistant (PDA), a Mobile Internet Device (MID), a Wearable Device or an in-vehicle device. It should be noted that a specific type of the terminal is not limited in the embodiments of this application.

In an optional embodiment of this application, a delay budget (PSDB) of a packet set is a delay budget for transmitting a packet set between a terminal and an anchor gateway.

In an optional embodiment of this application, an access network delay budget (Access Network PSDB, AN PSDB) of a packet set is a delay budget for transmitting a packet set between a terminal and a RAN network element.

In an optional embodiment of this application, a delay budget (PDB) of a packet is a delay budget for transmitting a packet between a terminal and an anchor gateway.

In an optional embodiment of this application, an access network delay budget (AN PDB) of a packet is a delay budget for transmitting a packet between a terminal and a RAN network element.

In an implementation, PDB=AN PDB (the PDB between the UE and the RAN)+CN PDB (a PDB between the RAN and a CN).

Second duration may be obtained by subtracting the CN PDB from first duration.

In an implementation, PSDB=AN PSDB (the PSDB between the UE and the RAN)+CN PDB (the PDB between the RAN and the CN).

In an implementation, an arrival time of the 1st packet in a first packet set is a start time of a delay budget of the first packet set.

In an implementation, a delay budget of a packet set is a delay budget per packet set.

In an optional embodiment of this application, a first access network delay budget or an access network delay budget of a packet set is an access network delay budget per packet set.

In an implementation, an access network delay budget of the first packet set may be short for a first access network delay budget of the first packet set.

In an optional embodiment of this application, a second access network delay budget is an access network delay budget per packet.

In an implementation, the delay budget of the first packet set may be referred to as a PSDB of the first packet set.

In an implementation, the access network delay budget of the first packet set may be referred to as an AN PSDB of the first packet set.

In an implementation, the second access network delay budget of the packet may be referred to as an AN PDB of the packet.

In an implementation, the PSDB includes an uplink PSDB or a downlink PSDB. The delay budget of the first packet set includes a delay budget of the first packet set in an uplink direction and a delay budget of the first packet set in a downlink direction. A first object includes a first object in the uplink direction and a first object in the downlink direction.

In an implementation, the downlink PSDB is a delay budget from a time at which the 1st packet arrives from N6 to the UPF to a time at which the RAN sends an Nth packet to the terminal.

In an implementation, the Nth packet is the last arriving packet (for example, last arrives at the UPF) that is in the first packet set and that meets a nineteenth condition (a condition of a first packet in the embodiment shown in FIG. 2). For example, there may be a plurality of packets in the first packet set that meet the nineteenth condition. The Nth packet is the last (that is, the last arriving) packet.

For example, when the packet arrives at the UPF, a difference obtained by subtracting second interval duration from the delay budget of the first packet set meets a first requirement. The second interval duration is interval duration between an arrival time of the Nth packet and an arrival time of the 1st packet; and

In another implementation, the Nth packet is the last packet in the first packet set.

In an implementation, the AN PSDB includes an uplink AN PSDB or a downlink AN PSDB

In an implementation, the downlink AN PSDB is a delay budget from a time at which the 1st packet arrives at the RAN to a time at which the RAN sends the Nth packet to the terminal.

The Nth packet is the last arriving packet (for example, arrives last at the RAN) that is in the first packet set and that meets a nineteenth condition (a condition of a first packet in the embodiment shown in FIG. 2). For example, there may be a plurality of packets in the first packet set that meet the nineteenth condition. The Nth packet is the last (that is, the last arriving) packet.

For example, when the packet arrives at the RAN, remaining duration of the first object (such as the access network delay budget of the first packet set in the downlink direction or a first timer) meets a second requirement. That the second requirement is met is one of the following: being greater than the AN PDB/the second duration, or being equal to the AN PDB/the second duration.

In another implementation, the Nth packet is the last packet in the first packet set.

In an implementation, the uplink PSDB is a delay budget from a time at which the 1st packet in the first packet set arrives at the UE (for example, arrives at a PDCP buffer of the UE and waits to be scheduled) and waits to be scheduled to a time at which the UPF sends the Nth packet to N3.

In an implementation, the 1st packet and the Nth packet are packets in a same packet set (such as the first packet set).

In an implementation, the Nth packet is the last arriving packet (for example, arrives at the UE) that is in the first packet set and that meets a nineteenth condition (a condition of a first packet in the embodiment shown in FIG. 2). For example, there may be a plurality of packets in the first packet set that meet the nineteenth condition. The Nth packet is the last (that is, the last arriving) packet.

A time at which the Nth packet arrives at the UE (for example, a time at which the packet arrives at the UE and waits to be scheduled) meets the nineteenth condition in the embodiment in FIG. 2. For example, when the packet arrives at the UE, remaining duration of the first object (such as the access network delay budget of the first packet set in the uplink direction or a first timer) meets a second requirement. That the second requirement is met is one of the following: being greater than the AN PDB/the second duration, or being equal to the AN PDB/the second duration.

In another implementation, the Nth packet is the last packet in the first packet set.

In an optional embodiment of this application, performing scheduling based on the PSDB or the AN PSDB (which may also be understood as delay guarantee per packet set) is determining a remaining delay budget of each packet based on a delay budget per a packet set. It is not difficult to understand that although arrival times of all packets are different, the arrival times all follow a time interval based on the first arriving packet. That is, the remaining delay budgets of all packets are the same.

In an optional embodiment of this application, performing scheduling based on the PDB or the AN PDB (which may also be understood as delay guarantee per packet) is determining a delay budget of each packet per PDB. It is not difficult to understand that the remaining delay budget of each packet is determined based on an arrival time of the packet, that is, the remaining delay budgets of all packets are different. Scheduling a packet based on the PDB or the AN PDB, means that the packet is no longer scheduled based on the PSDB or the AN PSDB.

In an implementation, remaining duration of the X1th object is one of the following: interval duration between a timeout time of the X1th object and a current time (the timeout time is after the current time, and the current time is a time for determining the remaining duration); or duration obtained by subtracting an elapsed time from duration of the X1th object.

For example, the duration of the X1th object is 10 s, and 6 s has elapsed since timing starts. In this case, the remaining duration is 4 s.

The X1th object is one of the following: the delay budget of the first packet set, the access network delay budget of the first packet set, the first timer of the first packet set, a second timer of a packet, an access network delay budget of a packet, or a delay budget of a packet.

In an implementation, when the 1st packet in the packet set arrives, timing of the X1th object starts.

In an implementation, the first timer is a discard timer per packet set. When the first timer of the first packet set expires or stops, all packets in the first packet set in a cache may be discarded.

In an implementation, when the 1st packet in the first packet set arrives, timing of the first timer of the first packet set starts.

In an implementation, the second timer is a discard timer per packet. When the second timer of the packet expires or stops, the packet in the cache is discarded.

A packet in a packet set may be controlled by both the first timer and the second timer. The packet is discarded only in a case that the two timers both expire or stop.

In an implementation, when a packet arrives, timing of a second timer of the packet starts.

In an implementation, the second timer is applied to the second packet, that is, the first timer is no longer applied to the second packet.

In an optional embodiment of this application, a time is one of the following: a time point, or a time stamp.

In an optional embodiment of this application, the packet is a packet cached in the terminal, or the packet set is a packet set cached in the terminal.

In an optional embodiment of this application, for a PDU set, the PDU set includes one or more PDUs. These PDUs carry a payload (for example, a frame or a video slice video slice) of an information unit generated at an application level. In some implementations, at an application layer, all PDUs in the PDU set need to use corresponding information units. In other implementations, the application layer may still recover all or part of the information units when some PDUs are lost.

In an optional embodiment of this application, the packet set may be referred to as a data set for short. The packet set includes one or more packets. Optionally, the packet set has a boundary.

In an optional embodiment of this application, the packet set is a concept in a cellular mobile communication network. The packet set may be a segment formed by one or more packets in a channel (for example, a QoS flow, QOS subflow, or a radio bearer), or a set formed by one or more packets.

In an optional embodiment of this application, the packet may be a PDU packet data unit.

In an optional embodiment of this application, the packet set may be one of the following: a packet data unit set PDU set, an instance of a PDU set, a PDU set category, an instance of a PDU set category, a data segment or a packet set in a channel (for example, a QoS flow, a QoS subflow, or a radio bearer).
(1) In an implementation, one PDU set category may include a plurality of PDU set instances. A PDU set category may be identified by using a PDU set identifier (for example, a QoS identifier at a PDU set level). A plurality of different PDU set instances of a same PDU set may be distinguished by using a packet set sequence number (for example, a PDU set sequence number).
(2) In another implementation, one PDU set category may include a plurality of PDU sets. The PDU set is the instance of the PDU set category. The PDU set category may be identified by using a PDU set identifier (for example, a QoS identifier at a PDU set level). A plurality of different PDU sets of a same PDU set category may be distinguished by using a packet set sequence number (for example, a PDU set sequence number).

In an optional embodiment of this application, the packet set category may be one of the following: a packet data unit set (PDU Set), or a channel (for example, a QoS flow, a QoS subflow, or a radio bearer). One packet set category may correspond to a plurality of packet sets. The packet set is the instance of the packet set category. The packet set category may be identified by using a packet set category identifier. The packet set category identifier is, for example, the QoS identifier at the packet set level. In this case, a plurality of packet sets may be distinguished by using a packet set sequence number.

In an implementation, the one or more packet sets are of a same category or different categories. Packet sets of different categories may be distinguished by using an identifier of a packet set. Different packet sets of a same category may be distinguished by using a sequence number of a packet set.

In an optional embodiment of this application, for a PDU set, the PDU set includes one or more PDUs. These PDUs carry a payload (for example, a frame or a video slice video slice) of an information unit generated at an application level. In some implementations, at an application layer, all PDUs in the PDU set need to use corresponding information units. In other implementations, the application layer may still recover all or part of the information units when some PDUs are lost.

In an optional embodiment of this application, the 1st packet in the packet set may be one of the following: a packet whose sequence number is the first in the packet set, or a packet that first arrives in the packet set.

In an optional embodiment of this application, the last packet in the packet set may be one of the following: a packet whose sequence number is the last in the packet set, or a packet that last arrives in the packet set.

In an optional embodiment of this application, the channel includes at least one of the following: a session (for example, a PDU session or a session between the RAN and the CN), a tunnel between the RAN and the CN, a QoS flow, a QoS subflow, an Evolved Packet System (EPS) bearer, a PDP context, a DRB, a Signalling Radio Bearer (SRB), a logical channel, an IPsec association, or a GPRS Tunnelling Protocol (GTP) tunnel. The channel may be instantiated as any one of the foregoing types of channels.

The following describes an information processing method in the embodiments of this application.

Referring to FIG. 2, an embodiment of this application provides an information processing method, applied to a first communication device. The first communication device includes but is not limited to one of the following: a RAN network element or a terminal, where the method includes:
Step 21: The first communication device obtains first information, where the first information includes at least one of the following: a PDU set delay budget (PSDB), a packet delay budget (PDB), an access network (AN) PSDB, an access network (AN) PDB, first duration, second duration, first interval duration, a first time, a second time, or first duration of a first timer.
Step 22: The first communication device performs a first operation based on the first information.

The first operation includes at least one of the following:
determining a delay budget of a first packet set;
determining duration of a first object;
modifying remaining duration of the delay budget of the first packet set, extending remaining duration of the delay budget of the first packet set, and/or restarting timing of the delay budget of the first packet set;
modifying remaining duration of the first object, extending remaining duration of the first object, and/or restarting timing of the first object;
stopping timing of the delay budget of the first packet set;
stopping timing of the first object;
applying, to a first packet, QoS, a delay, a timer, and/or an operation per packet set;
applying, to a second packet, QoS, a delay, a timer, and/or an operation per packet; or
setting a second access network delay budget or duration of a second timer of a third packet;
where
the first packet, the second packet, or the third packet is one or more packets in the first packet set;
the first object includes one of the following: a first timer of the first data set or an access network delay budget of the first data set, where the first timer is a discard timer used per packet set;
the second timer is a discard timer used per packet;
the first time is an arrival time of the 1st packet in the first packet set;
the second time is an arrival time of the last packet in the first packet set; and
the first interval duration is interval duration between the arrival time of the last packet in the first packet set and the arrival time of the 1st packet in the first packet set.

In an implementation, the first communication device includes but is not limited to one of the following: a terminal or a RAN network element.

The first communication device receives the first information from a fourth communication device.

In an implementation, the first packet set is a packet set.

In an implementation, the PDU set delay budget is a delay budget per packet set.

In an implementation, the first duration of the first timer is used to set initial duration of the first timer.

Optionally, the first duration is duration whose value is greater than or equal to the PDB;
and/or
the second duration is one of the following: duration whose value is greater than or equal to the AN PDB, or initial duration of the second timer;
and/or
the QoS, the delay, the timer, and/or the operation per packet set includes at least one of the following: the delay budget of the first packet set, the first timer of the first data set, the access network delay budget of the first data set, the PSDB, the AN PSDB, the first timer, scheduling based on the remaining duration of the delay budget of the first data set, or scheduling based on remaining duration of the access network delay budget of the first data set;
and/or
the QoS, the delay, the timer, and/or the operation per packet includes at least one of the following: the PDB, the AN PDB, the second timer, scheduling based on remaining duration of the PDB, scheduling based on remaining duration of the AN PDB, scheduling based on remaining duration of the packet delay budget, or scheduling based on remaining duration of the second access network delay budget.

In an implementation, the initial duration of the first timer is duration when the first timer starts or duration before timing starts.

The initial duration of the second timer is duration when the second timer starts or duration before timing starts.

In an implementation, the QoS, the delay, the timer, and/or the operation per packet set is not applied to the second packet. In another implementation, the following is applied to the second packet: (1) the QoS, the delay, the timer, and/or the operation per packet set; and (2) the QoS, the delay, the timer, and/or the operation per packet.

In an implementation, in a scenario in which both the QoS, the delay, the timer, and/or the operation per packet set and the QoS, the delay, the timer, and/or the operation per packet are applied, the first communication device discards a packet by following a timer whose duration is longer between the two timers (remaining duration of the first timer and remaining duration of the second timer).

In an implementation, in a scenario in which both the QoS, the delay, the timer, and/or the operation per packet set and the QoS, the delay, the timer, and/or the operation per packet are applied, the first communication device schedules a packet by following an object with shorter duration between a third object and a fourth object.

The third object may be one of the following: the remaining duration of the access network delay budget of the first packet set, or the remaining duration of the delay budget of the first packet set.

The fourth object may be one of the following: the remaining duration of the second access network delay budget, or the remaining duration of the packet delay budget.

Optionally, the determining a delay budget of a first packet set includes:
determining the delay budget of the first packet set based on at least one of the PSDB, the PDB, the first interval duration, the first time, the second time, or the first duration;
and/or
the determining duration of a first object includes:
determining the duration of the first object based on at least one of the AN PSDB, the first duration, the AN PDB, or the second duration;
and/or
the modifying remaining duration of the delay budget of the first packet set, and/or restarting timing of the delay budget of the first packet set includes:
modifying the remaining duration of the delay budget of the first packet set and/or restarting timing of the delay budget of the first packet set based on the PDB or the first duration;
and/or
the modifying remaining duration of the first object, and/or restarting timing of the first object includes:
modifying the remaining duration of the first object and/or restarting timing of the first object based on the AN PDB or the second duration.

In an implementation, the PDB or the first duration is referred to as the PDB/the first duration for short.

The AN PDB or the second duration may be referred to as the AN PDB/the second duration for short.

Optionally, the determining a delay budget of a first packet set includes one of the following:
determining that the delay budget of the first packet set is the PSDB;
determining that the delay budget of the first packet set is greater than or equal to the sum of the first interval duration and D1;
determining that the delay budget of the first packet set is greater than or equal to the sum of the first interval duration and D3; or
determining that the delay budget of the first packet set is greater than or equal to the sum of the PSDB and D1;
and/or
the modifying remaining duration of the delay budget of the first packet set, and/or restarting timing of the delay budget of the first packet set includes at least one of the following:
modifying the remaining duration of the delay budget of the first packet set to D1;
restarting timing of the delay budget of the first packet set, and setting duration of the delay budget of the first packet set to D1;
modifying the remaining duration of the delay budget of the first packet set to D3; or
restarting timing of the delay budget of the first packet set, and setting the duration of the delay budget of the first packet set to D3;
and/or
the modifying remaining duration of the first object, and/or restarting timing of the first object includes at least one of the following:
modifying the remaining duration of the first object to D4;
restarting timing of the first object, and setting the duration of the first object to D4;
modifying the remaining duration of the first object to D2; or
restarting timing of the first object, and setting the duration of the first object to D2;
and/or
the determining duration of a first object includes one of the following:
determining that the duration of the first object is duration greater than or equal to the AN PSDB;
determining that the duration of the first object is greater than or equal to the first duration of the first timer;
determining that the duration of the first object is greater than or equal to the sum of the first interval duration and D2;
determining that the duration of the first object is greater than or equal to the sum of the first interval duration and D4;
determining that the duration of the first object is greater than or equal to the sum of the AN PSDB and D2; or
determining that the duration of the first object is greater than or equal to the sum of the first duration of the first timer and D2;
where D1 is one of the following: the PDB, the first duration, duration greater than the PDB, or duration greater than the first duration;
D2 is one of the following: the AN PDB, the second duration, duration greater than the AN PDB, or duration greater than the second duration;
D3 meets the following condition: enabling a delay budget of the last arriving packet in the first packet set to meet a first requirement; and
D4 meets one of the following conditions: enabling the delay budget of the last arriving packet in the first packet set to meet the first requirement, or enabling a second access network delay budget or a second timer of the last arriving packet in the first packet set to meet a second requirement;
where
that the first requirement is met is one of the following: being greater than the PDB/the first duration, or being equal to the PDB/the first duration; and
that the second requirement is met is one of the following: being greater than the AN PDB/the second duration, or being equal to the AN PDB/the second duration;
where the first interval duration includes one of the following:
interval duration between the arrival time of the last packet in the first packet set and the arrival time of the 1st packet in the first packet set; or
interval duration between a time at which the last packet in the first packet set is determined to be lost and the arrival time of the 1st packet in the first packet set;
the PDB/the first duration is short for “the PDB or the first duration”; and
the AN PDB/the second duration is short for “the AN PDB or the second duration”.

In an implementation, in a case that the first object is the first timer of the first packet set, a value of the first object may be greater than or equal to one of the following: a value of the AN PSDB, the sum of the first interval duration and D2, the sum of the first interval duration and D4, or the sum of the AN PSDB and D2.

In an implementation, in a case that the first object is the access network delay budget of the first packet set, a value of the first object may be equal to one of the following: a value of the AN PSDB, the sum of the first interval duration and D2, the sum of the first interval duration and D4, or the sum of the AN PSDB and D2.

Optionally, the method further includes:
in a case that a first condition is met, determining that the delay budget of the first packet set is the PSDB;
where the first condition includes at least one of the following:
when the last packet in the first packet set is received, the remaining duration of the delay budget of the first packet set meets the first requirement;
when the last packet in the first packet set is determined to be lost, the remaining duration of the delay budget of the first packet set meets the first requirement; or
when the last packet in the first packet set is determined to be lost, remaining duration of the delay budget of the last arriving packet in the first packet set meets the first requirement;
where
that the first requirement is met is one of the following: being greater than the PDB/the first duration, or being equal to the PDB/the first duration;
the remaining duration of the delay budget of the last arriving packet is duration obtained by subtracting T1 from a timeout time of the delay budget of the first packet set;
T1 is interval duration between an arrival time of the last arriving packet in the first packet set and an arrival time of the first arriving packet in the first packet set; and
the PDB/the first duration is short for “the PDB or the first duration”.

In an implementation, the timeout time of the delay budget is a time at which timing of the delay budget ends.

Optionally, the method further includes:
in a case that a second condition is met, determining the delay budget of the first packet set;
and/or
in a case that a second condition is met, determining that the delay budget of the first packet set is greater than or equal to the sum of the first interval duration and D1;
and/or
in a case that a second condition is met, modifying the remaining duration of the delay budget of the first packet set to D1, and/or restarting timing of the delay budget of the first packet set, and setting the duration of the delay budget of the first packet set to D1;
where the second condition includes at least one of the following:
when a fourth packet or the last packet in the first packet set is received, the remaining duration of the delay budget of the first packet set is less than the PDB/the first duration;
when the last packet in the first packet set is determined to be lost, the remaining duration of the delay budget of the first packet set is less than the PDB/the first duration;
when the last packet in the first packet set is determined to be lost, remaining duration of the delay budget of the last arriving packet in the first packet set is less than the PDB/the first duration;
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
where a value of the first threshold is a non-zero value that approaches zero;
the PDB/the first duration is short for “the PDB or the first duration”; and
the fourth packet is a packet other than the last packet in the first packet set.

Optionally, in a case that the second condition includes “the remaining duration of the delay budget of the first packet set is less than the PDB/the first duration”, the second condition further includes: the delay budget of the first packet set does not time out;
and/or
in a case that the second condition includes “when the last packet in the first packet set is determined to be lost, the remaining duration of the delay budget of the first packet set is less than the PDB/the first duration”, the second condition further includes: a packet in the first packet set exists in a cache of the first communication device;
where the PDB/the first duration is short for “the PDB or the first duration”.

Optionally, the method further includes:
in a case that a third condition is met, determining that the duration of the first object is a value greater than or equal to the AN PSDB, or determining that the duration of the first object is greater than or equal to the first duration of the first timer;
where the third condition includes at least one of the following:
when the last packet in the first packet set is received, the remaining duration of the first object meets the second requirement;
when the last packet in the first packet set is determined to be lost, the remaining duration of the first object meets the second requirement; or
when the last packet in the first packet set is determined to be lost, remaining duration of the second access network delay budget or the second timer of the last arriving packet in the first packet set meets the second requirement;
where that the second requirement is met is one of the following: being greater than the AN PDB/the second duration, or being equal to the AN PDB/the second duration; and
the AN PDB/the second duration is short for “the AN PDB or the second duration”.

In an implementation, the remaining duration of the second access network delay budget or the second timer of the last arriving packet is one of the following:
interval duration between a current time and a timeout time of the second access network delay budget or the second timer (the timeout time is after the current time, and the current time is a time for determining the remaining duration); or
duration obtained by subtracting an elapsed time from duration of the second access network delay budget or the second timer.

For example, the duration of the second access network delay budget or the second timer is 10 s, and 6 s has elapsed since timing starts. In this case, the remaining duration is 4 s.

In an implementation, the second access network delay budget is, for example, the AN PDB.

Optionally, the method further includes:
in a case that a fourth condition is met, determining the duration of the first object;
and/or
in a case that a fourth condition is met, determining that the duration of the first object is greater than or equal to the sum of the first interval duration and D2;
and/or
in a case that a fourth condition is met, modifying the remaining duration of the first object to D2, or restarting the first object, and setting the duration of the first object to D2;
where the fourth condition includes at least one of the following:
when a fourth packet or the last packet in the first packet set is received, the remaining duration of the first object is less than the AN PDB/the second duration;
when the last packet in the first packet set is determined to be lost, the remaining duration of the first object is less than the AN PDB/the second duration;
when the last packet in the first packet set is determined to be lost, remaining duration of a second object of the last arriving packet in the first packet set is less than the AN PDB/the second duration;
the first object times out, or the remaining duration of the first object reaches a first threshold;
when the first object times out, the last packet in the first packet set is not received, or the last packet in the first packet set is not determined to be lost; or
when the remaining duration of the first object reaches the first threshold, the last packet in the first packet set is not received, or the last packet in the first packet set is not determined to be lost;
where
a value of the first threshold is a non-zero value that approaches zero;
the second object includes one of the following: the second timer or the second access network delay budget;
the AN PDB/the second duration is short for “the AN PDB or the second duration”; and
the fourth packet is a packet other than the last packet in the first packet set.

In an implementation, the second access network delay budget is, for example, the AN PDB.

Optionally, in a case that the fourth condition includes “the remaining duration of a delay budget of the first object is less than the AN PDB/the second duration”, the fourth condition further includes: the delay budget of the first object does not time out;
and/or
in a case that the fourth condition includes “when the last packet in the first packet set is determined to be lost, the remaining duration of a delay budget of the first object is less than the AN PDB/the second duration”, the fourth condition further includes: a packet in the first packet set exists in a cache of the first communication device;
where the AN PDB/the second duration is short for “the AN PDB or the second duration”.

Optionally, the method further includes:
in a case that a fifth condition is met, determining that the delay budget of the first packet set is greater than or equal to the sum of the first interval duration and D3;
and/or
in a case that a fifth condition is met, modifying the remaining duration of the delay budget of the first packet set to D3, and/or restarting timing of the delay budget of the first packet set, and setting the duration of the delay budget of the first packet set to D3;
and/or
in a case that a fifth condition is met, extending the remaining duration of the delay budget of the first packet set;
where the fifth condition includes at least one of the following:
when the last packet in the first packet set is determined to be lost, remaining duration of the delay budget of the last arriving packet in the first packet set is less than the PDB/the first duration; or
when the last packet in the first packet set is determined to be lost, duration obtained by subtracting T1 from a timeout time of the delay budget of the first packet set is less than the PDB/the first duration;
where
T1 is interval duration between an arrival time of the last arriving packet in the first packet set and an arrival time of the first arriving packet in the first packet set;
where
D3 or the extended remaining duration of the delay budget of the first packet set meets the following condition: enabling the delay budget of the last arriving packet in the first packet set to meet the first requirement;
that the first requirement is met is one of the following: being greater than the PDB/the first duration, or being equal to the PDB/the first duration; and
the PDB/the first duration is short for “the PDB or the first duration”.

In an implementation, the fifth condition further includes: the delay budget of the first packet set does not time out.

The delay budget of the last arriving packet is duration obtained by subtracting T2 from the timeout time of the delay budget of the first packet set, and T2 is the arrival time of the last arriving packet in the first packet set.

In an implementation, D3 is shown in FIG. 7.

In an implementation, D3 is less than the PDB/the first duration.

Optionally, the method further includes:
in a case that a sixth condition is met, modifying the remaining duration of the first object to D4, and/or restarting timing of the first object, and setting the duration of the first object to D4;
and/or
in a case that a sixth condition is met, extending the remaining duration of the first object, and/or restarting timing of the first object;
where the sixth condition includes one of the following:
when the last packet in the first packet set is determined to be lost, remaining duration of the delay budget of the last arriving packet in the first packet set is less than the AN PDB/the second duration; or
when the last packet in the first packet set is determined to be lost, duration obtained by subtracting T1 from a timeout time of the delay budget of the first packet set is less than the AN PDB/the second duration;
where
T1 is interval duration between an arrival time of the last arriving packet in the first packet set and an arrival time of the first arriving packet in the first packet set;
where
D4 or the extended remaining duration of the first object meets one of the following conditions: enabling the delay budget of the last arriving packet in the first packet set to meet the first requirement, or enabling the second access network delay budget or the second timer of the last arriving packet in the first packet set to meet the second requirement;
where
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;

the PDB/the first duration is short for “the PDB or the first duration”; and

the AN PDB/the second duration is short for “the AN PDB or the second duration”.

In an implementation, the second access network delay budget is, for example, the AN PDB.

In an implementation, the sixth condition further includes: the first object does not time out.

For the last arriving packet, the second access network delay budget of the packet is duration obtained by subtracting T2 from the timeout time of the first object, and T2 is the arrival time of the last arriving packet in the first packet set.

In an implementation, D4 is shown in FIG. 7.

Optionally, the method further includes:
in a case that a seventh condition is met, determining that the delay budget of the first packet set is greater than or equal to the sum of the PSDB and D1;
where the seventh condition includes at least one of the following:
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
where
a value of the first threshold is a non-zero value that approaches zero.

Optionally, the method further includes:
in a case that an eighth condition is met, determining that the duration of the first object is one of the following: greater than or equal to the sum of the AN PSDB and D2, or greater than or equal to the sum of the first duration of the first timer and D2;
where the eighth condition includes at least one of the following:
the first object times out, or the remaining duration of the first object reaches a first threshold;
when the first object times out, the last packet in the first packet set is not received, or the last packet in the first packet set is not determined to be lost; or
when the remaining duration of the first object reaches the first threshold, the last packet in the first packet set is not received, or the last packet in the first packet set is not determined to be lost;
where
a value of the first threshold is a non-zero value that approaches zero.

Optionally, the stopping timing of the delay budget of the first packet set includes:
in a case that a ninth condition is met, stopping timing of the delay budget of the first packet set;
where the ninth condition includes at least one of the following:
all packets in the first packet set are determined to be sent, or the last packet in the first packet set is determined to be lost;
a packet in the first packet set does not exist in a cache;
the delay budget of the first packet set does not time out;
the first object does not time out; or
a delay budget of the last received packet in the first packet set meets a first requirement;
where
that the first requirement is met is one of the following: being greater than the PDB/the first duration, or being equal to the PDB/the first duration; and
the PDB/the first duration is short for “the PDB or the first duration”.

Optionally, the stopping timing of the first object includes:
in a case that a tenth condition is met, stopping timing of the first object;
where the tenth condition includes at least one of the following:
all packets in the first packet set are determined to be sent, or the last packet in the first packet set is determined to be lost;
a packet in the first packet set does not exist in a cache;
the first object does not time out; or
a second access network delay budget or a second timer of the last received packet in the first packet set meets a second requirement;
where
that the second requirement is met is one of the following: being greater than the AN PDB/the second duration, or being equal to the AN PDB/the second duration; and
the AN PDB/the second duration is short for “the AN PDB or the second duration”.

In an implementation, the second access network delay budget is, for example, the AN PDB.

Optionally, the first packet includes a packet that is in the first packet set and that meets a nineteenth condition;
where the nineteenth condition includes at least one of the following:
a packet arrives within a first time interval;
a packet arrives between a start time of timing of the first object and a timeout time of the first object; or
a packet has a second interval duration less than or equal to one of the following: the access network delay budget of the first data set, the delay budget of the first packet set, or duration of the first timer;
a difference obtained by subtracting the second interval duration from the delay budget of the first packet set meets a first requirement;
a difference obtained by subtracting the second interval duration from the duration of the first object meets a second requirement;
when the packet arrives, the delay budget of the first packet set meets the first requirement; and
when the packet arrives, the remaining duration of the first object meets the second requirement;
where
that the first requirement is met is one of the following: being greater than the PDB/the first duration, or being equal to the PDB/the first duration; and
that the second requirement is met is one of the following: being greater than the AN PDB/the second duration, or being equal to the AN PDB/the second duration;
where
the second interval duration is interval duration between an arrival time of the packet and the arrival time of the 1st packet;
the PDB/the first duration is short for “the PDB or the first duration”; and
the AN PDB/the second duration is short for “the AN PDB or the second duration”.

In an implementation, the start time of timing is a time at which timing starts.

In an implementation, the timeout time is a time at which timing ends (stops).

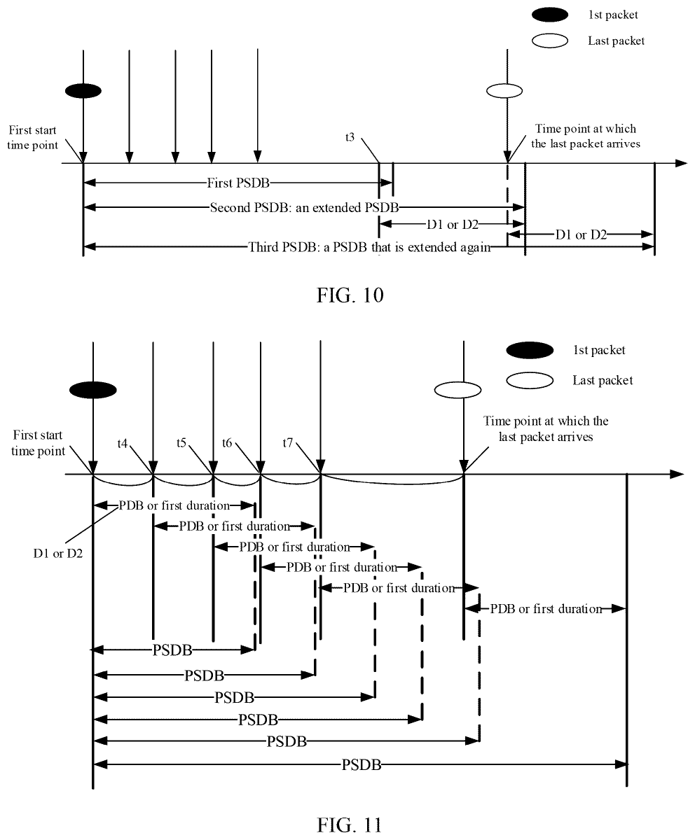

In an implementation, if a packet arrives after the first time interval (for example, a time interval of the first PSDB shown in FIG. 10), scheduling is performed based on the PDB, that is, the PSDB is not guaranteed. The PSDB is guaranteed only for a packet arriving within an initial PSDB interval.

In an implementation, the packet arriving between the start time of timing of the first object and the timeout time of the first object includes a packet whose second interval duration is less than or equal to one of the following: the access network delay budget of the first data set, the delay budget of the first packet set, or the duration of the first timer. Subsequent descriptions are similar, and are not described again. The duration of the first timer is, for example, total timing duration of the first timer.

In an implementation, an arrival time of a packet may also be referred to as a receiving time of the packet. For example, the second interval duration may also be referred to as interval duration between the receiving time of the packet and the receiving time of the 1st packet. Subsequent descriptions are similar, and are not described again.

Optionally, the second packet includes a packet that is in the first packet set and that meets a twentieth condition;
where the twentieth condition includes at least one of the following:
a packet arrives after a first time interval;
a packet arrives after a timeout time of the delay budget, a timeout time of the access network delay budget, or an expiry time of the first timer of the first packet set; or
a packet has a second interval duration greater than or equal to one of the following: the access network delay budget of the first data set, the delay budget of the first packet set, or duration of the first timer;
a difference obtained by subtracting the second interval duration from the delay budget of the first packet set is less than the PDB/the first duration;
a difference obtained by subtracting the second interval duration from the duration of the first object is less than the AN PDB/the second duration;
when the packet arrives, the delay budget of the first packet set is less than the PDB/the first duration; and
when the packet arrives, the remaining duration of the first object is less than the AN PDB/the second duration;
where
the second interval duration is interval duration between an arrival time of the packet and the arrival time of the 1st packet;
the PDB/the first duration is short for “the PDB or the first duration”; and
the AN PDB/the second duration is short for “the AN PDB or the second duration”.

In an implementation, a packet arriving after the timeout time of the delay budget, the timeout time of the access network delay budget, or the expiry time of the first timer of the first packet set includes a packet whose second interval duration is greater than or equal to one of the following: the access network delay budget of the first data set, the delay budget of the first packet set, or the duration of the first timer.

In an implementation, the twentieth condition further includes: allowing not to discard the packet (for example, allowing to transmit the packet).

In another implementation, a packet arrives after the first time interval (for example, a packet arrives after the timeout time of the third PSDB shown in FIG. 10) is scheduled based on the PDB, that is, the PSDB is not guaranteed. The PSDB is guaranteed only for a packet arriving in an extension interval (for example, a time interval from the timeout time of the first PSDB to the timeout time of the third PSDB shown in FIG. 10).

Optionally, the first time interval is a time interval between a start time of the first time interval and an end time of the first time interval; and
the start time of the first time interval is based on one of the following: the arrival time of the 1st packet in the first packet set, a time at which timing of the delay budget the first packet set starts, a time at which timing of the access network delay budget of the first packet set starts, or a time at which timing of the first timer of the first packet set starts;
and/or
the end time of the first time interval is based on one of the following: a time at which the delay budget of the first packet set times out, a time at which the access network delay budget of the first packet set times out, or a time at which the first timer of the first packet set expires, or a third time;
and/or
duration of the first time interval is one of the following:
the PSDB;
a difference obtained by subtracting the PDB/the first duration from the PSDB;
the sum of the PSDB and the PDB;
the sum of the PSDB and the first duration;
the AN PSDB;
a difference obtained by subtracting the AN PDB/the second duration from the AN PSDB;
the sum of the AN PSDB and the AN PDB; or
the sum of the AN PSDB and the second duration;
where
the third time meets one of the following:
a time at which the remaining duration of the delay budget of the first packet set is greater than or equal to the PDB/the first duration; or
a time at which the remaining duration of the first object is greater than or equal to the AN PDB/the second duration;
the PDB/the first duration is short for “the PDB or the first duration”; and
the AN PDB/the second duration is short for “the AN PDB or the second duration”.

Optionally, the setting a second access network delay budget or duration of a second timer of a third packet includes at least one of the following:
setting the second access network delay budget or the duration of the second timer to the remaining duration of the first object;
in a case that timing of the first object is restarted, restarting timing of the second access network delay budget or the second timer;
when the third packet is received, in a case that a thirteenth condition is met, setting, by the first communication device, the second access network delay budget or the duration of the second timer of the third packet based on the remaining duration of the first object, or setting the second access network delay budget or the duration of the second timer to the remaining duration of the first object; or
when the third packet is received, in a case that a fourteenth condition is met, setting, by the first communication device, the second access network delay budget or the duration of the second timer of the third packet based on the AN PDB/the second duration, or setting the second access network delay budget or the duration of the second timer to D2;
where
the thirteenth condition includes one of the following: the remaining duration of the delay budget of the first packet set meets a first requirement, remaining duration of the access network delay budget of the first packet set meets a second requirement, or remaining duration of the first timer meets the second requirement;
the fourteenth condition includes one of the following: the remaining duration of the delay budget of the first packet set is less than the PDB/the first duration, the remaining duration of the access network delay budget of the first packet set meets the second requirement, or the remaining duration of the first timer is less than the AN PDB/the second duration;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget or the second timer needs to be greater than or equal to the AN PDB. If the remaining duration of the delay budget of the first packet set is less than the PDB (or the remaining duration of the first object (the first timer of the first packet set or the access network delay budget of the first packet set) is less than the AN PDB) because the packet arrives relatively late, the second timer of the packet is set based on the AN PDB. It is not difficult to understand that in this implementation, a packet arriving before the remaining duration of the delay budget of the first packet set is greater than the PDB (or the remaining duration of the first object (the first timer of the first packet set or the access network delay budget of the first packet set) is greater than the AN PDB) is managed by following the PSDB. A packet arriving when the remaining duration of the delay budget of the first packet set is less than the remaining duration of the PDB is managed by following the PDB instead of the PSDB.

In an implementation, the third packet is one or more packets in the packet set.

In an implementation, the setting, by the first communication device, the duration of the second timer based on the AN PDB/the second duration includes: setting the duration of the second timer to a value greater than the AN PDB/the second duration, or setting the duration of the second timer to a value equal to the AN PDB/the second duration.

In this embodiment of this application, for a specified fixed packet set delay budget, the first communication device may modify the packet set delay budget one or more times, to eliminate a case in which the packet set delay budget is insufficient or the packet set delay budget has timed out when a PDU arrives at the RAN due to an N6 jitter.

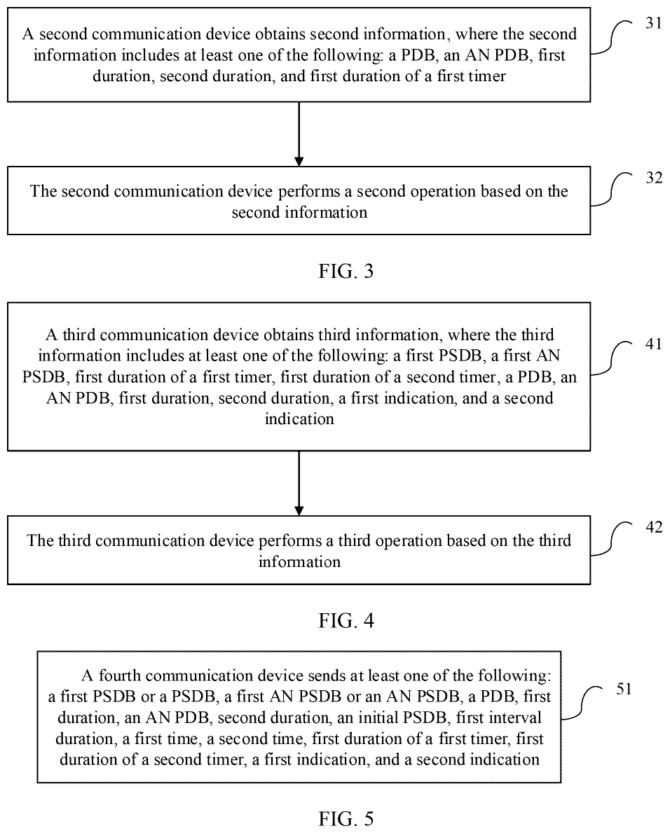

Referring to FIG. 3, an embodiment of this application provides an information processing method, applied to a second communication device. The second communication device includes but is not limited to one of the following: a RAN network element or a terminal, where the method includes:
Step 31: The second communication device obtains second information, where the second information includes at least one of the following: a PDB, an AN PDB, first duration, second duration, or first duration of a first timer.
Step 32: The second communication device performs a second operation based on the second information, where the second operation includes at least one of the following:
determining a delay budget of a first packet set or duration of the first timer;
determining duration of a first object;
restarting timing of the delay budget of the first packet set;
restarting timing of the first object; or
setting a second access network delay budget or duration of a second timer of a third packet;
where
the third packet is one or more packets in the first packet set;
the first object includes one of the following: a first timer of the first data set or a first access network delay budget of the first data set;
the first timer is a discard timer used per packet set; and
the second timer is a discard timer used per packet.

In an implementation, the second communication device includes but is not limited to a terminal and a RAN network element.

The second communication device receives the second information sent by a fourth communication device.

In an implementation, the first duration of the first timer is used to set initial duration of the first timer.

Optionally, the first duration is duration whose value is greater than or equal to the PDB; and
the second duration is one of the following: duration whose value is greater than or equal to the AN PDB, or initial duration of the second timer.

In an implementation, the initial duration of the first timer is duration when the first timer starts or duration before timing starts.

In an implementation, the initial duration of the second timer is duration when the second timer starts or duration before timing starts.

Optionally, in a case that an eleventh condition is met, timing of the delay budget of the first packet set is restarted, or timing of the first object is restarted, where
the eleventh condition includes:
a packet in the first packet set arrives.

In an implementation, the packet in the first packet set does not include a packet first arriving in the first packet set.

It is not difficult to understand that the delay budget of the first packet set increases as the packet is received. In an implementation, a time interval between arrival of adjacent packets in a same packet set is less than or equal to the PDB.

Optionally, the determining a delay budget of a first packet set or duration of the first timer includes at least one of the following:
determining the delay budget of the first packet set based on the PDB or the first duration; or
determining the duration of the first timer based on a difference between the PDB and a CN PDB or a difference between the first duration and a CN PDB.

Optionally, the determining a delay budget of a first packet set or duration of the first timer includes at least one of the following:
setting initial duration of the delay budget of the first packet set to D1;
setting initial duration of the first timer to one of the following: greater than or equal to the difference between the PDB and the CN PDB, or greater than or equal to the difference between the first duration and the CN PDB;
setting remaining duration of the delay budget of the first packet set to D1; or
restarting timing of the delay budget of the first packet set, and/or setting duration of the delay budget of the first packet set to D1;
where
D1 is one of the following: the PDB, the first duration, duration greater than the PDB, or duration greater than the first duration.

In an implementation, the setting includes modification.

In an implementation, when the 1st packet in the packet set arrives, timing of the delay budget of the first packet set starts. An arrival time of the 1st packet in the packet set is a start time of the delay budget of the first packet set.

Optionally, the setting remaining duration of the delay budget of the first packet set to D1, and restarting timing of the delay budget of the first packet set, and/or setting duration of the delay budget of the first packet set to D1 includes at least one of the following:
when an M1th packet arrives, if the delay budget of the first packet set has timed out, restarting timing of the delay budget of the first packet set, and/or setting the duration of the delay budget of the first packet set to D1; or
when the M1th packet arrives, setting the remaining duration of the delay budget of the first packet set to D1, and restarting timing of the delay budget of the first packet set, and/or setting the duration of the delay budget of the first packet set to D1;
where M1 is one of the following: an integer greater than or equal to 1, or an integer greater than or equal to 2.

In an implementation, when the M1th packet arrives, if the delay budget of the first packet set has timed out, the second communication device restarts timing of the delay budget of the first packet set, and the second communication device may further restart the first timer.

In an implementation, the modifying the remaining duration of the delay budget of the first packet set to the first duration when the M1th packet arrives includes: when the M1th PDU arrives and the remaining duration of the delay budget of the first packet set is not zero, modifying the remaining duration of the delay budget of the first packet set to the first duration.

In an implementation, the M1th packet is a packet in a packet set.

In an implementation, M1 may be predefined or preconfigured as each packet in the first packet set. In this case, as shown in the figure, provided that a packet in the first packet set arrives, the remaining duration of the delay budget of the first packet set is modified to the PDB.

Optionally, the determining duration of a first object includes:
determining the duration of the first object based on the AN PDB or the second duration.

Optionally, the determining duration of a first object includes at least one of the following:
setting initial duration of the first object to D2;
setting remaining duration of the first object to D2; or
restarting timing of the first object, and/or setting the duration of the first object to D2;
where the first object includes one of the following: the first timer of the first data set or the access network delay budget of the first data set;
the first timer is a discard timer used per packet set; and
D2 is one of the following: the AN PDB, the second duration, duration greater than the AN PDB, or duration greater than the second duration.

In an implementation, when the 1st packet in the packet set arrives, timing of the first timer starts.

Optionally, the setting remaining duration of the first object to D2, and restarting timing of the first object, and/or setting the duration of the first object to D2 includes at least one of the following:
when an M2th packet arrives, if the first object has timed out, restarting timing of the first object, and/or setting the duration of the first object to D2; or
when the M2th packet arrives, modifying the remaining duration of the first object to D2, and restarting timing of the first object, and/or setting the duration of the first object to D2;
where M2 is one of the following: an integer greater than or equal to 1, or an integer greater than or equal to 2.

In an implementation, when the M2th packet arrives, if the first timer expires, the second communication device restarts timing of the delay budget of the first packet set, and the second communication device may further restart the first timer.

In an implementation, the modifying the remaining duration of the first timer to the AN PDB/the second duration when the M2th packet arrives includes: when the M2th packet arrives, if the first timer does not expires, modifying the remaining duration of the first timer to the AN PDB/the second duration.

In an implementation, the M2th packet is a packet in a packet set.

Optionally, the method further includes:
in a case that a twelfth condition is met, performing at least one of the following operations:
setting remaining duration of the delay budget of the first packet set to D1;
restarting timing of the delay budget of the first packet set, and/or setting duration of the delay budget of the first packet set to D1;
setting remaining duration of the first object to D2; or
restarting timing of the first object, and/or setting the duration of the first object to D2;
where
the twelfth condition includes:
an arrival time of an M3th packet is later than a fourth time, where the fourth time is one of the following:
a time at which the remaining duration of the delay budget of the first packet set is less than the PDB/the first duration;
a time at which remaining duration of the first timer is less than the AN PDB or the second duration;
a time at which the delay budget of the first packet set times out; or
a time at which the first object times out;
where M3 is one of the following: an integer greater than or equal to 1, or an integer greater than or equal to 2;
where
D1 is one of the following: the PDB, the first duration, duration greater than the PDB, or duration greater than the first duration;
D2 is one of the following: the AN PDB, the second duration, duration greater than the AN PDB, or duration greater than the second duration; and
the PDB/the first duration is short for “the PDB or the first duration”.

In an implementation, the setting, by the second communication device, the remaining duration of the delay budget of the first packet set to the PDB/the first duration when the M3th packet arrives includes: when the M3th packet arrives and the remaining duration of the delay budget of the first packet set is not zero, modifying the remaining duration of the delay budget of the first packet set to the PDB/the first duration.

In an implementation, the setting, by the second communication device, the remaining duration of the first object to D2 when the M3th packet arrives includes: when the M3th packet arrives, and the first object does not time out, modifying the remaining duration of the first object to D2.

By using the foregoing implementations, it is not difficult to understand, the second communication device is prevented from performing the second operation each time a packet is received, thereby reducing overheads.

Optionally, the setting a second access network delay budget or duration of a second timer of a third packet includes at least one of the following:
setting the second access network delay budget or the duration of the second timer to remaining duration of the first object;
in a case that timing of the first object is restarted, restarting timing of the second access network delay budget or the second timer;
when the third packet is received, in a case that a thirteenth condition is met, setting, by the second communication device, the second access network delay budget or the duration of the second timer of the third packet based on the remaining duration of the first object, or setting the second access network delay budget or the duration of the second timer to the remaining duration of the first object; or
when the third packet is received, in a case that a fourteenth condition is met, setting, by the second communication device, the second access network delay budget or the duration of the second timer of the third packet based on the AN PDB/the second duration, or setting the second access network delay budget or the duration of the second timer to D2;
where
the thirteenth condition includes one of the following: remaining duration of the delay budget of the first packet set meets a first requirement, remaining duration of the access network delay budget of the first packet set meets a second requirement, or remaining duration of the first timer meets the second requirement;
the fourteenth condition includes one of the following: the remaining duration of the delay budget of the first packet set is less than the PDB/the first duration, the remaining duration of the access network delay budget of the first packet set meets the second requirement, or the remaining duration of the first timer is less than the AN PDB/the second duration;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget or the second timer needs to be greater than or equal to the AN PDB. If the remaining duration of the delay budget of the first packet set is less than the PDB (or the remaining duration of the first object (the first timer of the first packet set or the access network delay budget of the first packet set) is less than the AN PDB) because the packet arrives relatively late, the second timer of the packet is set based on the AN PDB. It is not difficult to understand that in this implementation, a packet arriving before the remaining duration of the delay budget of the first packet set is greater than the PDB (or the remaining duration of the first object (the first timer of the first packet set or the access network delay budget of the first packet set) is greater than the AN PDB) is managed by following the PSDB. A packet arriving when the remaining duration of the delay budget of the first packet set is less than the remaining duration of the PDB is managed by following the PDB instead of the PSDB.

In an implementation, the third packet is one or more packets in the packet set.

In this embodiment of this application, when receiving a packet, the second communication device can determine an applicable packet set delay budget in a timely manner, to eliminate a case in which the packet set delay budget is insufficient or the packet set delay budget has timed out when a PDU arrives at the RAN due to an N6 jitter.

Referring to FIG. 4, an embodiment of this application provides an information processing method, applied to a third communication device. The third communication device includes but is not limited to one of the following: a RAN network element or a terminal, where the method includes:
Step 41: The third communication device obtains third information, where the third information includes at least one of the following: a first PSDB, a first AN PSDB, first duration of a first timer, first duration of a second timer, a PDB, an AN PDB, first duration, second duration, a first indication, or a second indication.
Step 42: The third communication device performs a third operation based on the third information, where the third operation includes at least one of the following:
setting initial duration of a delay budget of a first packet set to one of the following: an infinite value or a first value;
setting initial duration of a first object to one of the following: an infinite value or a second value;
modifying remaining duration of the delay budget of the first packet set, and/or restarting timing of the delay budget of the first packet set;
modifying remaining duration of the first object, and/or restarting timing of the first object;
stopping timing of the delay budget of the first packet set;
stopping timing of the first object; or
setting a second access network delay budget or duration of a second timer of a third packet;
where
the first PSDB is used to indicate an infinite value or the first value;
the first AN PSDB or the first duration of the first timer is used to indicate an infinite value or the second value;
the first value or the second value meets the following condition: being long enough for the third communication device to determine that the last packet in the first packet set is lost, or being long enough for the third communication device to receive the last packet in the first packet set;
the third packet is one or more packets in the first packet set;
the first object includes one of the following: a first timer of the first data set or an access network delay budget of the first data set;
the first timer is a discard timer used per packet set; and
the second timer is a discard timer used per packet;
where
the first object includes one of the following: the first timer of the first data set, the access network delay budget of the first data set, the AN PSDB, or the first timer;
where
the first indication is used to indicate at least one of the following:
an initial value of the PSDB or the delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify the remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the third communication device includes but is not limited to a terminal and a RAN network element.

The third communication device receives the third information sent by a fourth communication device.

In an implementation, at a time point at which the last packet in the first packet set is determined to be lost or at a time point after the time point, if no packet in the first packet set exists in a cache (it indicates that the packet in the first packet set has been sent), the third communication device does not perform any operation.

In an implementation, the first condition further includes at least one of the following:
when the last packet in the first packet set is received, the remaining duration of the delay budget of the first packet set meets the first requirement;
when the last packet in the first packet set is determined to be lost, the remaining duration of the delay budget of the first packet set meets the first requirement; or
when the last packet in the first packet set is determined to be lost, remaining duration of the delay budget of the last arriving packet in the first packet set meets the first requirement;
where
that the first requirement is met is one of the following: being greater than the PDB/the first duration, or being equal to the PDB/the first duration; and
the remaining duration of the delay budget of the last arriving packet is duration obtained by subtracting T1 from a timeout time of the delay budget of the first packet set, and T1 is interval duration between an arrival time of the last arriving packet in the first packet set and an arrival time of the first arriving packet in the first packet set.

In an implementation, the second condition further includes at least one of the following:
when a packet or the last packet in the first packet set is received, the remaining duration of the delay budget of the first packet set is less than the PDB/the first duration;
when the last packet in the first packet set is determined to be lost, the remaining duration of the delay budget of the first packet set is less than the PDB/the first duration;
when the last packet in the first packet set is determined to be lost, remaining duration of the delay budget of the last arriving packet in the first packet set is less than the PDB/the first duration;
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
where a value of the first threshold is a non-zero value that approaches zero.

Optionally, the first duration is duration whose value is greater than or equal to the PDB; and
the second duration is one of the following: duration whose value is greater than or equal to the AN PDB, or initial duration of the second timer.

In an implementation, the initial duration of the first timer is duration when the first timer starts or duration before timing starts.

In an implementation, the initial duration of the second timer is duration when the second timer starts or duration before timing starts.

Optionally, the modifying remaining duration of the delay budget of the first packet set, and/or restarting timing of the delay budget of the first packet set includes at least one of the following:
modifying the remaining duration of the delay budget of the first packet set to the PDB/the first duration;
restarting timing of the delay budget of the first packet set, and setting the duration of the delay budget of the first packet set to the PDB/the first duration;
modifying the remaining duration of the delay budget of the first packet set to D3;
restarting timing of the delay budget of the first packet set, and setting the duration of the delay budget of the first packet set to D3; or
shortening the remaining duration of the delay budget of the first packet set;
and/or
the modifying remaining duration of the first object, and/or restarting timing of the first object includes at least one of the following:
modifying the remaining duration of the first object to the AN PDB/the second duration;
restarting timing of the first object, and setting the duration of the first object to the AN PDB/the second duration;
modifying the remaining duration of the first object to D4;
restarting timing of the first object, and setting the duration of the first object to D4;

or
shortening the remaining duration of the first object;
where
D3 meets the following condition: enabling the delay budget of the last arriving packet in the first packet set to meet the first requirement;
D4 or the shortened remaining duration of the first object meets one of the following conditions: enabling the delay budget of the last arriving packet in the first packet set to meet the first requirement, or enabling the second access network delay budget or the second timer of the last arriving packet in the first packet set to meet the second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

Optionally, in a case that a fifteenth condition is met, at least one of the following operations is performed:
modifying the remaining duration of the delay budget of the first packet set and/or restarting timing of the delay budget of the first packet set based on the PDB/the first duration;
modifying the remaining duration of the first object and/or restarting timing of the first object based on the AN PDB/the second duration;
modifying the remaining duration of the delay budget of the first packet set to the PDB/the first duration;
restarting timing of the delay budget of the first packet set, and setting the duration of the delay budget of the first packet set to D1; or
modifying the remaining duration of the first object to D2, or restarting timing of the first object, and setting the duration of the first object to D2;
where the fifteenth condition includes one of the following:
the last packet in the first packet set arrives; or
the last packet in the first packet set is determined to be lost;
where
D1 is one of the following: the PDB, the first duration, duration greater than the PDB, or duration greater than the first duration; and
D2 is one of the following: the AN PDB, the second duration, duration greater than the AN PDB, or duration greater than the second duration;
where
the PDB/the first duration is short for “the PDB or the first duration”; and
the AN PDB/the second duration is short for “the AN PDB or the second duration”.

In an implementation, in a case that the twelfth condition includes “the last packet in the first packet set is determined to be lost”, the fifth condition further includes: a packet in the first packet set exists in a cache.

In an implementation, in a case that D1 is greater than the PDB or the first duration, D1 is less than an infinite value or the first value.

Optionally, the modifying remaining duration of the delay budget of the first packet set, and/or restarting timing of the delay budget of the first packet set includes:
in a case that a sixteenth condition is met, modifying the remaining duration of the delay budget of the first packet set to D3, and/or restarting timing of the delay budget of the first packet set, and setting the duration of the delay budget of the first packet set to D3;
where the sixteenth condition includes at least one of the following:
the last packet in the first packet set is determined to be lost;
when the last packet in the first packet set is determined to be lost, remaining duration of the delay budget of the last arriving packet in the first packet set is less than the PDB/the first duration;
when the last packet in the first packet set is determined to be lost, the remaining duration of the delay budget of the last arriving packet in the first packet set is less than the PDB/the first duration; or
when the last packet in the first packet set is determined to be lost, duration obtained by subtracting T1 from a timeout time of the delay budget of the first packet set is less than the PDB/the first duration;
where T1 is interval duration between an arrival time of the last arriving packet in the first packet set and an arrival time of the first arriving packet in the first packet set;
where
D3 meets the following condition: enabling the delay budget of the last arriving packet in the first packet set to meet the first requirement; and
the PDB/the first duration is short for “the PDB or the first duration”.

Optionally, the modifying remaining duration of the first object, and/or restarting timing of the first object includes:
in a case that a seventeenth condition is met, modifying the remaining duration of the first object to D4, restarting timing of the first object, and setting the duration of the first object to D4, and/or shortening the remaining duration of the first object;
where the seventeenth condition includes at least one of the following:
the last packet in the first packet set is determined to be lost;
when the last packet in the first packet set is determined to be lost, remaining duration of the delay budget of the last arriving packet in the first packet set is less than the AN PDB/the second duration; or
when the last packet in the first packet set is determined to be lost, duration obtained by subtracting T1 from a timeout time of the delay budget of the first packet set is less than the AN PDB/the second duration;
where
T1 is interval duration between an arrival time of the last arriving packet in the first packet set and an arrival time of the first arriving packet in the first packet set;
D4 or the shortened remaining duration of the first object meets one of the following conditions: enabling the delay budget of the last arriving packet in the first packet set to meet the first requirement, or enabling the second access network delay budget or the second timer of the last arriving packet in the first packet set to meet the second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget is, for example, the AN PDB.

In an implementation, the sixth condition further includes: the first object does not time out.

The delay budget of the last arriving packet is duration obtained by subtracting T2 from a timeout time of the first object, and T2 is an arrival time of the last arriving packet in the first packet set.

In an implementation, D4 is shown in FIG. 7.

Optionally, the stopping timing of the delay budget of the first packet set includes:
in a case that the last packet in the first packet set is determined to be lost and an eighteenth condition is met, stopping, by the third communication device, timing of the delay budget of the first packet set;
where the eighteenth condition includes at least one of the following:
a packet in the first packet set does not exist in a cache;
the delay budget of the first packet set does not time out; or
a delay budget of the last received packet in the first packet set meets the first requirement;
where
that the first requirement is met is one of the following: being greater than the PDB/the first duration, or being equal to the PDB/the first duration; and
the PDB/the first duration is short for “the PDB or the first duration”.

Optionally, the stopping timing of the first object includes:
in a case that a tenth condition is met, stopping timing of the first object;
where the tenth condition includes at least one of the following:
all packets in the first packet set are determined to be sent, or the last packet in the first packet set is determined to be lost;
a packet in the first packet set does not exist in a cache;
the first object does not time out; or
a second access network delay budget or a second timer of the last received packet in the first packet set meets the second requirement;
where
that the second requirement is met is one of the following: being greater than the AN PDB/the second duration, or being equal to the AN PDB/the second duration; and
the AN PDB/the second duration is short for “the AN PDB or the second duration”.

In an implementation, the second access network delay budget is, for example, the AN PDB.

Optionally, the setting a second access network delay budget or duration of a second timer of a third packet includes at least one of the following:
setting the second access network delay budget or the duration of the second timer to the remaining duration of the first object;
in a case that timing of the first object is restarted, restarting timing of the second access network delay budget or the second timer;
when the third packet is received, in a case that a thirteenth condition is met, setting, by the first communication device, the second access network delay budget or the duration of the second timer of the third packet based on the remaining duration of the first object, or setting the second access network delay budget or the duration of the second timer to the remaining duration of the first object; or
when the third packet is received, in a case that a fourteenth condition is met, setting, by the first communication device, the second access network delay budget or the duration of the second timer of the third packet based on the AN PDB/the second duration, or setting the second access network delay budget or the duration of the second timer to D2;
where
the thirteenth condition includes one of the following: the remaining duration of the delay budget of the first packet set meets the first requirement, remaining duration of the access network delay budget of the first packet set meets the second requirement, or remaining duration of the first timer meets the second requirement;
the fourteenth condition includes one of the following: the remaining duration of the delay budget of the first packet set is less than the PDB/the first duration, the remaining duration of the access network delay budget of the first packet set meets the second requirement, or the remaining duration of the first timer is less than the AN PDB/the second duration;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget or the second timer needs to be greater than or equal to the AN PDB. If the remaining duration of the delay budget of the first packet set is less than the PDB (or the remaining duration of the first object (the first timer of the first packet set or the access network delay budget of the first packet set) is less than the AN PDB) because the packet arrives relatively late, the second timer of the packet is set based on the AN PDB. It is not difficult to understand that in this implementation, a packet arriving before the remaining duration of the delay budget of the first packet set is greater than the PDB (or the remaining duration of the first object (the first timer of the first packet set or the access network delay budget of the first packet set) is greater than the AN PDB) is managed by following the PSDB. A packet arriving when the remaining duration of the delay budget of the first packet set is less than the remaining duration of the PDB is managed by following the PDB instead of the PSDB.

In an implementation, the third packet is one or more packets in the packet set.

In this embodiment of this application, for a packet set delay budget whose duration has been set to be excessively long, the third communication device may narrow the packet set delay budget to a sufficient packet set delay budget, to eliminate a case in which the packet set delay budget is insufficient or the packet set delay budget has timed out when a PDU arrives at the RAN due to an N6 jitter.

Referring to FIG. 5, an embodiment of this application provides an information processing method, applied to a fourth communication device. The fourth communication device includes but is not limited to one of the following: a CN network element (such as a PCF, an SMF), a RAN network element, or a terminal. The method includes:
Step 51: The fourth communication device sends at least one of the following:
a first PSDB or a PSDB, a first AN PSDB or an AN PSDB, a PDB, first duration, an AN PDB, second duration, an initial PSDB, first interval duration, a first time, a second time, first duration of a first timer, first duration of a second timer, a first indication, or a second indication;
where
the first time is an arrival time of the 1st packet in a first packet set;
the second time is an arrival time of the last packet in the first packet set, or a time at which the last packet in the first packet set is determined to be lost; and
the first interval duration is interval duration between the arrival time of the last packet in the first packet set and the arrival time of the 1st packet in the first packet set;
where
the first PSDB is used to indicate an infinite value or a first value;
the first AN PSDB or the first duration of the first timer is used to indicate an infinite value or a second value;
the first value or the second value meets the following condition: being long enough for a third communication device to determine that the last packet in the first packet set is lost, or being long enough for a third communication device to receive the last packet in the first packet set;
the first timer is a discard timer used per packet set; and
the second timer is a discard timer used per packet;
where
a first object includes one of the following: a first timer of the first data set, an access network delay budget of the first data set, the AN PSDB, or the first timer;
where
the first indication is used to indicate at least one of the following:
an initial value of the PSDB or a delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the fourth communication device includes but is not limited to a terminal, a RAN network element, and a CN network element. The fourth communication device may send the foregoing information to at least one of the following: a first communication device, a second communication device, a third communication device, a RAN network element, or a terminal.

In a case that the first communication device, the second communication device, or the third communication device is a RAN network element, the fourth communication device may be a CN network element, or a terminal.

In a case that the first communication device, the second communication device, or the third communication device is a terminal, the fourth communication device may be a CN network element, or a RAN network element.

In an implementation, the fourth communication device performs at least one of the following operations based on at least one of the first PSDB or the PSDB, the first AN PSDB or the AN PSDB, the PDB, the first duration, the AN PDB, the second duration, the initial PSDB, the first interval duration, the first time, the second time, the first duration of the first timer, the first duration of the second timer, the first indication, and the second indication: sending first information to the first communication device, sending second information to the second communication device, or sending third information to the third communication device.

In an implementation, the fourth communication device sends the first PSDB, the first AN PSDB, the first duration of the first timer, the first duration of the second timer, the PDB, the AN PDB, the first duration, the second duration, the first indication, and the second indication to the third communication device,
where
the first PSDB is used to indicate an infinite value or a first value;
the first AN PSDB or the first duration of the first timer is used to indicate an infinite value or a second value; and
the first value or the second value meets the following condition: being long enough for the third communication device to determine that the last packet in the first packet set is lost, or being long enough for the third communication device to receive the last packet in the first packet set;
where
the first indication is used to indicate at least one of the following:
the initial value of the PSDB or the delay budget of the first packet set is an infinite value;
the initial value of the PSDB or the delay budget of the first packet set is the first value;
in a case that the first condition is met, it is required to modify the remaining duration of the PSDB or the delay budget of the first packet set to the PDB or the first duration, or restart timing of the PSDB or the delay budget of the first packet set, and set the duration of the PSDB or the delay budget of the first packet set to the PDB or the first duration; or
in a case that the second condition is met, it is required to modify the remaining duration of the PSDB to D3, or restart timing of the PSDB, and set the duration of the PSDB to D3;
where
the second indication is used to indicate at least one of the following:
the initial value of the first object is an infinite value or the second value;
in a case that the second condition is met, it is required to modify the remaining duration of the first object to the AN PDB or the second duration, or restart timing of the first object, and set the duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
the first object includes one of the following: the first timer of the first data set or the access network delay budget of the first data set;
D3 meets the following condition: enabling the delay budget of the last arriving packet in the first packet set to meet the first requirement;
D4 meets one of the following conditions: enabling the delay budget of the last arriving packet in the first packet set to meet the first requirement, or enabling the second access network delay budget or the second timer of the last arriving packet in the first packet set to meet the second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the first duration that is of the first timer and that is sent by the fourth communication device to the first communication device or the second communication device is used to set the initial duration of the first timer.

Optionally, the first duration is duration whose value is greater than or equal to the PDB; and
the first duration is duration whose value is greater than or equal to the PDB;
and/or
the second duration is one of the following: duration whose value is greater than or equal to the AN PDB, or initial duration of the second timer.

In this embodiment of this application, the first information may be sent to the first communication device, the second information may be sent to the second communication device, and the third information may be sent to the third communication device, so that a receive end device performs a corresponding operation to obtain an applicable packet set delay budget, to eliminate a case in which the packet set delay budget is insufficient or the packet set delay budget has timed out when a PDU arrives at the RAN due to an N6 jitter.

Application Scenario 1 of the Embodiments of this Application:

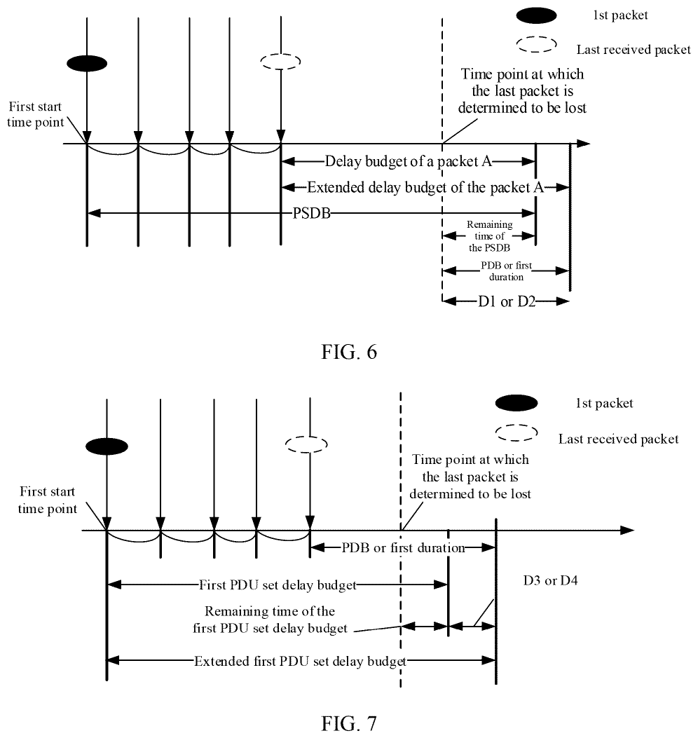

The application scenario 1 of the embodiments of this application mainly describes an operation performed by the first communication device such as a RAN network element at a time point at which the last packet in the first packet set is determined to be lost. Refer to FIG. 6. The PSDB in the figure is the delay budget of the first packet set.

In a case that the second condition is met (for example, in FIG. 6, at the time at which the last packet in the first packet set is determined to be lost, the PSDB does not time out, but the remaining duration of the PSDB is less than the PDB), the first communication device modifies the remaining duration of the PSDB to D1 (for example, the PDB or the first duration). Modifying the remaining duration of the PSDB to D1 may be implemented by restarting timing of the PSDB and setting the duration of the PSDB to D1. The extended (modified) PSDB=(the time point at which last packet in the first packet set is determined to be lost−a first start time point)+D1.

Alternatively, in a case that the fourth condition is met (for example, in FIG. 6, at the time point at which the last packet in the first packet set is determined to be lost, the remaining duration of the first object is less than the AN PDB/the second duration), the first communication device modifies the remaining duration of the first object to D2. Modifying the remaining duration of the first object to D2 may be implemented by restarting the first object and setting the duration of the first object to D2. The first object includes one of the following: the first timer of the first packet set or the access network delay budget of the first packet set.

In addition, for the last received packet in the first packet set, for example, a packet A, the first communication device may further set duration of a second timer of the packet A based on the PDB. Herein, the duration of the second timer of the packet A is an extended delay budget of the packet A in FIG. 6. It should be noted that in FIG. 6, the first start time point is a time point at which timing of the PSDB starts, namely, a time point at which the 1st packet in the first packet set arrives.

Application Scenario 2 of the Embodiments of this Application:

The application scenario 2 of the embodiments of this application mainly describes an operation performed by the first communication device such as a RAN network element at a time point at which the last packet in the first packet set is determined to be lost. Refer to FIG. 7.

With reference to descriptions in the embodiment in FIG. 2, in a case the fifth condition is met (for example, in FIG. 7, at the time point at which the last packet in the first packet set is determined to be lost, the PSDB does not time out, and duration obtained by subtracting T1 from the timeout time of the PSDB is less than the PDB), the first communication device modifies the remaining duration of the PSDB to D3. Modifying the remaining duration of the PSDB to D3 may be implemented by restarting timing of the PSDB and setting the duration of the PSDB to D3. The first communication device may determine: the extended (modified) PSDB=(the time point at which last packet in the first packet set is determined to be lost−a first start time point)+D3.

As shown in FIG. 7, in this case, D3=PDB−(t1−t2), t1 is the time point at which the last packet in the first packet set is determined to be lost, and t2 is a time point at which the last received packet in the first packet set arrives.

Alternatively, with reference to descriptions in the embodiment in FIG. 2, in a case that the sixth condition is met (implementationally, for example, in FIG. 7, in a case that the last packet in the first packet set is determined to be lost, the remaining duration of the delay budget of the last arriving packet (the last received packet) in the first packet set is less than the AN PDB or the second duration), the first communication device modifies the remaining duration of the first object to D4. Modifying the remaining duration of the first object to D4 may be implemented by restarting timing of the first object and setting the duration of the first object to D4. The first object includes one of the following: the first timer of the first packet set or the access network delay budget of the first packet set. The second object includes one of the following: the second timer or the second access network delay budget.

It should be noted that in FIG. 7, the first start time point is a time point at which timing of the PSDB starts, namely, a time point at which the 1st packet in the first packet set arrives.

Application Scenario 3 of the Embodiments of this Application:

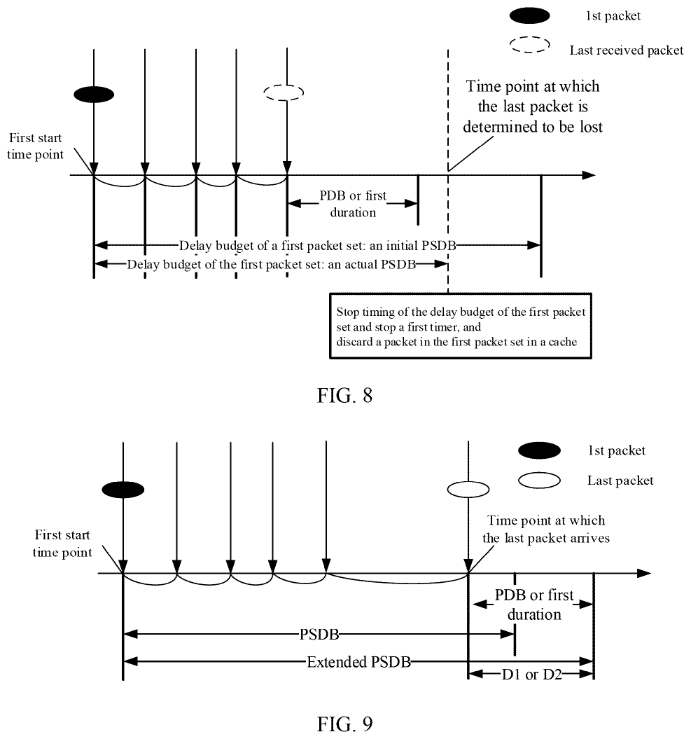

The application scenario 3 of the embodiments of this application mainly describes an operation performed by the first communication device such as a RAN network element in a case that the last packet in the first packet set is determined to be lost. Refer to FIG. 8.

As shown in FIG. 8, with reference to descriptions in the embodiment in FIG. 2, in a case that the last packet in the first packet set is determined to be lost and the ninth condition is met, timing of the delay budget of the first packet set is stopped.

As shown in FIG. 8, with reference to descriptions in the embodiment in FIG. 2, in a case that the last packet in the first packet set is determined to be lost and the tenth condition is met, the first communication device stops timing of the first object.

In this case, the first information device may further discard the packet in the first packet set in the cache.

As shown in FIG. 8, because the first communication device stops timing of the PSDB before the initial PSDB times out, an actual PSDB is equal to duration between the first start time point and the time point at which the last packet in the first packet set is determined to be lost.

It should be noted that the first start time point in FIG. 8 is a time point at which timing of the PSDB (the initial PSDB or the actual PSDB) starts, namely, the time point at which the 1st packet in the first packet set arrives.

Application Scenario 4 of the Embodiments of this Application:

The application scenario 4 of the embodiments of this application mainly describes an operation performed by the first communication device such as a RAN network element when the first packet set is received and in a case that the last packet in the first packet set is received.

The PSDB in the figure is a first PDU set delay budget.

With reference to the embodiment of the first communication device in FIG. 2, in a case that the second condition is met (as shown in FIG. 9, at the time point at which the last packet in the first packet set arrives, the PSDB does not time out, and the remaining duration of the PSDB is less than the PDB or the first duration), the first communication device modifies the remaining duration of the PSDB to D1, or restarts timing of the PSDB, and sets the duration of the delay budget of the PSDB to D1. The first communication device may determine: the extended (modified) PSDB=(the time point at which last packet in the first packet set arrives−the first start time point)+D1.

With reference to the embodiment of the first communication device in FIG. 2, or in a case that the fourth condition is met (for example, in FIG. 9, at the time point at which the last packet in the first packet set is determined to arrive), the first communication device modifies the remaining duration of the first object to D2, or restarts the first object, and sets the duration of the first object to D2. The first object includes one of the following: the first timer of the first packet set or the access network delay budget of the first packet set.

It should be noted that in FIG. 9, the first start time point is a time point at which timing of the PSDB starts, namely, a time point at which the 1st packet in the first packet set arrives.

Certainly, at the time point at which the last packet in the first packet set arrives, if the PSDB does not time out, and the remaining duration of the PSDB is greater than or equal to the first duration, the first communication device does not perform any operation.

Application Scenario 5 of the Embodiments of this Application:

The application scenario 5 of the embodiments of this application mainly describes an operation performed by the first communication device such as a RAN network element in a case that the PSDB is about to time out (t3) and the last packet in the first packet set is received. Refer to FIG. 10. The PSDB in the figure is a first PDU set delay budget.
Step 1: With reference to the embodiment of the first communication device in FIG. 2, in a case that the second condition is met (as shown in FIG. 10, the PSDB (namely, the first PSDB) does not time out, but the remaining duration of the first PSDB reaches the first threshold (that is, the first PSDB is about to time out)), the first communication device modifies the remaining duration of the PSDB to D1. For example, as shown in FIG. 10, D1=the PDB or the first duration, and the first communication device may determine: a second PSDB (namely, the extended (modified) PSDB)=(t3−the first start time point)+D1.
With reference to the embodiment of the first communication device in FIG. 2, or in a case that the fourth condition is met, the first communication device modifies the duration of the first object to D2. The first object includes one of the following: the first timer of the first packet set or the access network delay budget of the first packet set.
Step 2: With reference to the embodiment of the first communication device in FIG. 2, in a case that the second condition is met (as shown in FIG. 10, at the time point at which the last packet in the first packet set arrives, the PSDB (namely, the second PSDB) does not time out, and remaining duration of the second PSDB is less than the first duration), the first communication device modifies the remaining duration of the second PSDB to D1. For example, as shown in FIG. 10, D1=the PDB or the first duration, and the first communication device may determine: a third PSDB (namely, the PSDB that is extended (modified) again)=(the time point at which the last packet arrives-a first start time point)+D1.

It should be noted that in FIG. 10, the first start time point is a time point at which timing of the PSDB starts, namely, a time point at which the 1st packet in the first packet set arrives.

In this scenario, because the last packet arrives beyond the first PSDB and close to the second PSDB, to avoid a plurality of times of extension (modification), in an implementation, the second PSDB is determined by performing extension only one time, and a packet arriving in an extended interval (namely, a time interval from a timeout time of the first PSDB to a timeout time of the second PSDB) or after the extended interval is scheduled based on the PDB, that is, the PSDB is not guaranteed.

Application Scenario 6 of the Embodiments of this Application:

The application scenario 6 of the embodiments of this application mainly describes an operation performed by the second communication device such as a RAN network element at a first start time point, t4 (a time point at which the 2nd packet in the first packet set arrives), t5 (a time point at which the 3rd packet in the first packet set arrives), t6 (a time point at which the 4th packet in the first packet set arrives), t7 (a time point at which the 5th packet in the first packet set arrives), and a time point at which the last packet in the first packet set arrives. Refer to FIG. 11. It should be noted that in FIG. 11, the first start time point is a time point at which timing of the PSDB starts, namely, a time point at which the 1st packet in the first packet set arrives. The PSDB in the figure is a first PDU set delay budget.

At the first start time point, the PSDB is set to D1. As shown in FIG. 11, D1 is equal to the PDB or the first duration. In this case, the initial duration of the first object may be further set to D2. As shown in FIG. 11, D2 is equal to the AN PDB or the second duration.

At t4 (M1=2), the PSDB does not time out. The second communication device sets the remaining duration of the PSDB to D1, or restarts timing of the PSDB, and sets the duration of the PSDB to D1. In this case, the second communication device may determine: the extended (modified) PSDB=(t4−the first start point)+D1. In addition, the device may further set the remaining duration of the first object set to D2, restart timing of the first object, and set the duration of the first object to D2.

At t5 (M1=3), the PSDB does not time out, and the second communication device sets the remaining duration of the PSDB to D1. In this case, the second communication device may determine: the extended (modified) PSDB=(t5−the first start time point)+D1.

At t6 (M1=4), the PSDB does not time out, and the second communication device sets the remaining duration of the PSDB to D1. In this case, the second communication device may determine: the extended (modified) PSDB=(t6−the first start time point)+D1.

At t7 (M1=5), the PSDB does not time out, and the second communication device sets the remaining duration of the PSDB to D1. In this case, the second communication device may determine: the extended (modified) PSDB=(t7−the first start time point)+D1.

At the time point at which the last packet in the first packet set arrives, the PSDB does not time out, and the second communication device modifies the remaining duration of the PSDB to D1. In this case, the second communication device may determine: the extended (modified) PSDB=(the time point at which last packet in the first packet set arrives−the first start time point)+D1.

In this way, regardless of whether the last packet in the first packet set is lost, an impact caused by an N6 jitter can be eliminated.

Application Scenario 7 of the Embodiments of this Application:

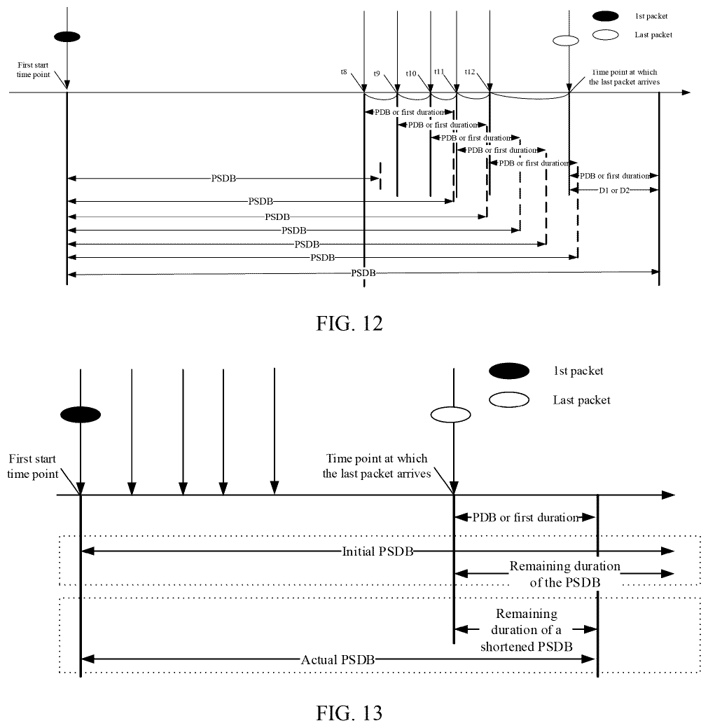

The application scenario 7 of the embodiments of this application mainly describes an operation performed by the second communication device such as a RAN network element at a first start time point, t8 (a time point at which the 2nd packet in the first packet set arrives), t9 (a time point at which the 3rd packet in the first packet set arrives), t10 (a time point at which the 4th packet in the first packet set arrives), t11 (a time point at which the 5th packet in the first packet set arrives), t12 (a time point at which the 6th packet in the first packet set arrives), and a time point at which the last packet in the first packet set arrives. Refer to FIG. 12. It should be noted that in FIG. 12, the first start time point is a time point at which timing of the PSDB starts, namely, a time point at which the 1st packet in the first packet set arrives. The PSDB in the figure is a first PDU set delay budget.

At the first start time point, the PSDB is set to D1, and D1 is greater than or equal to the PDB or the first duration. In this case, the initial duration of the first object may be further set to D2. As shown in FIG. 12, D2 is greater than or equal to the AN PDB or the second duration.

At t8 (M3−2), because the remaining duration of the PSDB at a time point before t8 is less than the PDB, that is, the twelfth condition is met, the second communication device sets the remaining duration of the PSDB to D1, or restarts timing of the PSDB, and sets the duration of the PSDB to D1. D1 is the PDB or the first duration. In this case, the second communication device may determine: the extended (modified) PSDB=(t8−the first start time point)+D1. In addition, the device may further set the remaining duration of the first object set to D2, restart timing of the first object, and set the duration of the first object to D2.

At t9 (M3=3), because the remaining duration of the PSDB at a time point before t9 is less than the PDB, that is, the twelfth condition is met, the second communication device sets the remaining duration of the PSDB to D1. D1 is the PDB or the first duration. In this case, the second communication device may determine: the extended (modified) PSDB=(t9−the first start time point)+D1.

At t10 (M3=4), because the remaining duration of the PSDB at a time point before t10 is less than the PDB, that is, the twelfth condition is met, the second communication device sets the remaining duration of the PSDB to D1. D1 is the PDB or the first duration. In this case, the second communication device may determine: the extended (modified) PSDB=(t10−the first start time point)+D1.

At t11 (M3=5), because the remaining duration of the PSDB at a time point before t11 is less than the PDB, that is, the twelfth condition is met, the second communication device sets the remaining duration of the PSDB to D1. D1 is the PDB or the first duration. In this case, the second communication device may determine: the extended (modified) PSDB=(t11−the first start time point)+D1.

At t12 (M3=6), because the remaining duration of the PSDB at a time point before t12 is less than the PDB, that is, the twelfth condition is met, the second communication device sets the remaining duration of the PSDB to D1. D1 is the PDB or the first duration. In this case, the second communication device may determine: the extended (modified) PSDB=(t12−the first start time point)+D1.

At the time point at which the last packet in the first packet set arrives, because the remaining duration of the PSDB has been less than the PDB before the time point at which the last packet arrives, the second communication device modifies the remaining duration of the PSDB to D1. D1 is the PDB or the first duration. In this case, the second communication device may determine: the extended (modified) PSDB=(the time point at which last packet in the first packet set arrives−the first start time point)+D1.

In this way, the second communication device performs the second operation (for example, update the PSDB or update the remaining duration of the PSDB) only for a packet received in a case that the PSDB is about to time out, thereby reducing overheads.

Application Scenario 8 of the Embodiments of this Application:

The application scenario 8 of the embodiments of this application mainly describes an operation performed by the third communication device such as a RAN network element at a first start time point and a time point at which the last packet in the first packet set is received. Refer to FIG. 13. It should be noted that in FIG. 13, the first start time point is a time point at which timing of the PSDB starts, namely, a time point at which the 1st packet in the first packet set arrives. The PSDB in the figure is a first PDU set delay budget.

At the first start time point, the PSDB is set to the initial PSDB, and the initial PSDB is used to indicate an infinite value. In this case, the initial duration of the first object may be further set to an infinite value.

In a case that the fifteenth condition is met (for example, the last packet in the first packet set arrives), the third communication device modifies the remaining duration of the first object to the AN PDB or the second duration, or restarts timing of the first object, and sets the duration of the first object to the AN PDB or the second duration.

Application Scenario 9 of the Embodiments of this Application:

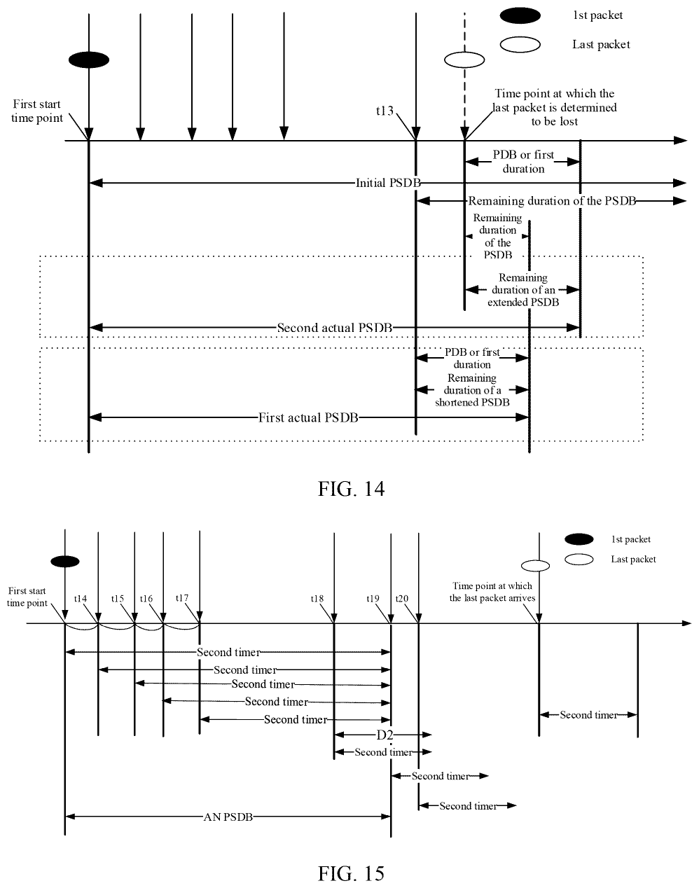

The application scenario 9 of the embodiments of this application mainly describes an operation performed by the third communication device such as a RAN network element at a first start time point, an arrival time of arrival (t13) of the last arriving packet in the first packet set, and a time point at which the last packet in the first packet set is determined to be lost. Refer to FIG. 14. It should be noted that in FIG. 14, the first start time point is a time point at which timing of the PSDB starts, namely, a time point at which the 1st packet in the first packet set arrives. The PSDB in the figure is a first PDU set delay budget.

At the first start time point, the PSDB is set to the initial PSDB, and the initial PSDB is used to indicate an infinite value. In this case, the initial duration of the first object may be further set to an infinite value.

In a case that the fifteenth condition is met (for example, the last packet in the first packet set is determined to be lost), the third communication device modifies the remaining duration of the first object to the AN PDB or the second duration, or restarts timing of the first object, and sets the duration of the first object to the AN PDB or the second duration.

In a case that the sixteenth condition is met (for example, the last packet in the first packet set is determined to be lost; or when the last packet in the first packet set is determined to be lost, the remaining duration of the delay budget of the last arriving packet in the first packet set is less than the PDB/the first duration), the remaining duration of the delay budget of the first packet set is modified to D3, or timing of the delay budget of the first packet set is restarted, and the duration of the delay budget of the first packet set is set to D3.

In a case that the sixth condition is met (for example, it is determine that the last packet in the first packet set is lost; or when it is determined that the last packet in the first packet set is lost, the remaining duration of the delay budget of the last arriving packet in the first packet set is less than the AN PDB/the second duration), the remaining duration of the first object is modified to D4, timing of the first object is restarted and the duration of the first object is set to D4, or the remaining duration of the first object is shortened.

Application Scenario 10 of the Embodiments of this Application:

The application scenario 10 of the embodiments of this application mainly describes an operation performed, when the first packet set such as the first packet set is received, by the first communication device such as a RAN network element at a first start time point, t14 (a time point at which the 2nd packet in the first packet set arrives), t15 (a time point at which the 3rd packet in the first packet set arrives), t16 (a time point at which the 4th packet in the first packet set arrives), t17 (a time point at which the 5th packet in the first packet set arrives), t18 (a time point at which the 6th packet in the first packet set arrives), t19 (a time point at which the 7th packet in the first packet set arrives), t20 (a time point at which the 8th packet in the first packet set arrives), and a time point at which the last packet in the first packet set arrives. Refer to FIG. 15. It should be noted that in FIG. 15, the first start time point is a time point at which timing of the AN PSDB starts, namely, a time point at which the 1st packet in the first packet set arrives. The AN PSDB in the figure is the access network delay budget of the first packet set. The second timer in the figure is a second discard timer.

At the first start time point, the remaining duration of the AN PSDB meets the second requirement (greater than or equal to the AN PDB/the second duration), and the first communication device sets a second timer of the 1st packet to the remaining duration of the first timer. In this case, the remaining duration of the first timer is equal to the AN PSDB, that is, the second timer of the 1st packet=the AN PSDB

At t14, the remaining duration of the AN PSDB meets the second requirement, and the first communication device sets a second timer of the 2nd packet to the remaining duration of the first timer. In this case, the remaining duration of the first timer is equal to the remaining duration of the AN PSDB, that is, the second timer of the 2nd packet=the AN PSDB−(t14−the first start time point).

At t15, the remaining duration of the AN PSDB meets the second requirement, and the first communication device sets a second timer of the 3rd packet to the remaining duration of the first timer. In this case, the remaining duration of the first timer is equal to the remaining duration of the AN PSDB, that is, the second timer of the 3rd packet=the AN PSDB−(t15−the first start time point).

At t16, the remaining duration of the AN PSDB meets the second requirement, and the first communication device sets a second timer of the 4th packet to the remaining duration of the first timer. In this case, the remaining duration of the first timer is equal to the remaining duration of the AN PSDB, that is, the second timer of the 4th packet=the AN PSDB−(t16−the first start time point).

At t17, the remaining duration of the AN PSDB meets the second requirement, and the first communication device sets a second timer of the 5th packet to the remaining duration of the first timer. In this case, the remaining duration of the first timer is equal to the remaining duration of the AN PSDB, that is, the second timer of the 5th packet=the AN PSDB−(t17−the first start time point).

At t18, the remaining duration of the AN PSDB is less than the AN PDB/the second duration, and the first communication device sets a second timer of the 6th packet to D2. D2 is the AN PDB or the second duration.

At t19, which is the timeout time of the AN PSDB, the remaining duration of the AN PSDB is less than the AN PDB/the second duration, and the first communication device sets a second timer of the 7th packet to D2. D2 is the AN PDB or the second duration.

At t20, the AN PSDB times out, the first communication device sets a second timer of the 8th packet to D2. D2 is the AN PDB or the second duration.

At the time point at which the last packet in the first packet set arrives, because the AN PSDB has timed out before the time point at which the last packet arrives, the first communication device sets a second timer of the last packet to D2. D2 is the AN PDB or the second duration.

It should be further noted that, in FIG. 15, a packet arriving before a target time point (the remaining duration of the AN PSDB is equal to the AN PDB) is managed by following the AN PSDB (which may also be understood as scheduling based on the AN PSDB). A packet arriving after the target time point is managed by following the AN PDB instead of the AN PSDB (which may also be understood as scheduling based on the AN PDB).

The information processing method provided in the embodiments of this application may be performed by an information processing apparatus. In the embodiments of this application, an example in which the information processing apparatus performs the information processing method is used to describe the information processing apparatus provided in the embodiments of this application.

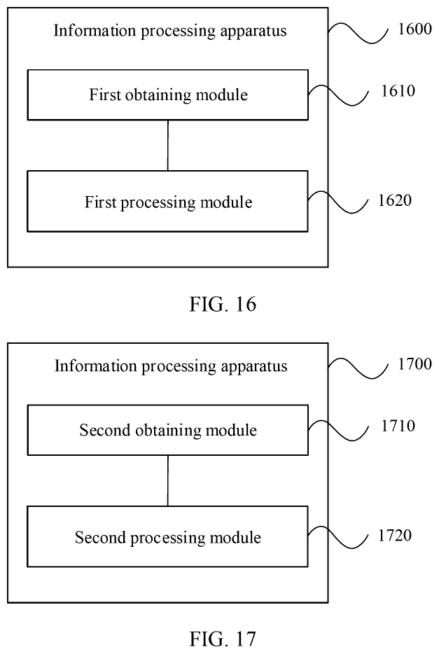

Referring to FIG. 16, FIG. 16 is a schematic diagram of a structure of an information processing apparatus according to an embodiment of this application. The apparatus is applied to a first communication device. As shown in FIG. 16, the information processing apparatus 1600 includes:
a first obtaining module 1610, configured to obtain first information, where the first information includes at least one of the following: a PDU set delay budget (PSDB), a packet delay budget (PDB), an access network (AN) PSDB, an access network (AN) PDB, first duration, second duration, first interval duration, a first time, a second time, or first duration of a first timer; and
a first processing module 1620, configured to perform a first operation based on the first information.

The first operation includes at least one of the following:
determining a delay budget of a first packet set;
determining duration of a first object;
modifying remaining duration of the delay budget of the first packet set, extending remaining duration of the delay budget of the first packet set, or restarting timing of the delay budget of the first packet set;
modifying remaining duration of the first object, extending remaining duration of the first object, or restarting timing of the first object;
stopping timing of the delay budget of the first packet set;
stopping timing of the first object;
applying, to a first packet, QoS, a delay, a timer, and/or an operation per packet set;
applying, to a second packet, QoS, a delay, a timer, and/or an operation per packet; or
setting a second access network delay budget or duration of a second timer of a third packet;
where
the first packet, the second packet, or the third packet is one or more packets in the first packet set;
the first object includes one of the following: a first timer of the first data set, or an access network delay budget of the first data set, where the first timer is a discard timer used per packet set;
the second timer is a discard timer used per packet;
the first time is an arrival time of the 1st packet in the first packet set;
the second time is an arrival time of the last packet in the first packet set; and
the first interval duration is interval duration between the arrival time of the last packet in the first packet set and the arrival time of the 1st packet in the first packet set.

Optionally, the first duration is duration whose value is greater than or equal to the PDB;
and/or
the second duration is one of the following: duration whose value is greater than or equal to the AN PDB, or initial duration of the second timer;
and/or
the QoS, the delay, the timer, and/or the operation per packet set includes at least one of the following: the delay budget of the first packet set, the first timer of the first data set, the access network delay budget of the first data set, the PSDB, the AN PSDB, the first timer, scheduling based on the remaining duration of the delay budget of the first data set, or scheduling based on remaining duration of the access network delay budget of the first data set;
and/or
the QoS, the delay, the timer, and/or the operation per packet includes at least one of the following: the PDB, the AN PDB, the second timer, scheduling based on remaining duration of the PDB, scheduling based on remaining duration of the AN PDB, scheduling based on remaining duration of the packet delay budget, or scheduling based on remaining duration of the second access network delay budget.

In an implementation, the initial duration of the first timer is duration when the first timer starts or duration before timing starts.

The initial duration of the second timer is duration when the second timer starts or duration before timing starts.

In an implementation, the QoS, the delay, the timer, and/or the operation per packet set is not applied to the second packet. In another implementation, the following is applied to the second packet: (1) the QoS, the delay, the timer, and/or the operation per packet set; and (2) the QoS, the delay, the timer, and/or the operation per packet.

In an implementation, in a scenario in which both the QoS, the delay, the timer, and/or the operation per packet set and the QoS, the delay, the timer, and/or the operation per packet are applied, the first communication device discards a packet by following a timer whose duration is longer between the two timers (remaining duration of the first timer and remaining duration of the second timer).

In an implementation, in a scenario in which both the QoS, the delay, the timer, and/or the operation per packet set and the QoS, the delay, the timer, and/or the operation per packet are applied, the first communication device schedules a packet by following an object with shorter duration between a third object and a fourth object.

The third object may be one of the following: the remaining duration of the access network delay budget of the first packet set, or the remaining duration of the delay budget of the first packet set.

The fourth object may be one of the following: the remaining duration of the second access network delay budget, or the remaining duration of the packet delay budget.

Optionally, the determining a delay budget of a first packet set includes:
determining the delay budget of the first packet set based on at least one of the PSDB, the PDB, the first interval duration, the first time, the second time, or the first duration;
and/or
the determining duration of a first object includes:
determining the duration of the first object based on at least one of the AN PSDB, the first duration, the AN PDB, or the second duration;
and/or
the modifying remaining duration of the delay budget of the first packet set, and/or restarting timing of the delay budget of the first packet set includes:
modifying the remaining duration of the delay budget of the first packet set and/or restarting timing of the delay budget of the first packet set based on the PDB or the first duration;
and/or
the modifying remaining duration of the first object, and/or restarting timing of the first object includes:
modifying the remaining duration of the first object and/or restarting timing of the first object based on the AN PDB or the second duration.

In an implementation, the PDB or the first duration is referred to as the PDB/the first duration for short.

The AN PDB or the second duration may be referred to as the AN PDB/the second duration for short.

Optionally, the determining a delay budget of a first packet set includes one of the following:
determining that the delay budget of the first packet set is the PSDB;
determining that the delay budget of the first packet set is greater than or equal to the sum of the first interval duration and D1;
determining that the delay budget of the first packet set is greater than or equal to the sum of the first interval duration and D3; or
determining that the delay budget of the first packet set is greater than or equal to the sum of the PSDB and D1;
and/or
the modifying remaining duration of the delay budget of the first packet set, and/or restarting timing of the delay budget of the first packet set includes at least one of the following:
modifying the remaining duration of the delay budget of the first packet set to D1;
restarting timing of the delay budget of the first packet set, and setting duration of the delay budget of the first packet set to D1;
modifying the remaining duration of the delay budget of the first packet set to D3; or
restarting timing of the delay budget of the first packet set, and setting the duration of the delay budget of the first packet set to D3;
and/or
the modifying remaining duration of the first object, and/or restarting timing of the first object includes at least one of the following:
modifying the remaining duration of the first object to D4;
restarting timing of the first object, and setting the duration of the first object to D4; and
modifying the remaining duration of the first object to D2; or
restarting timing of the first object, and setting the duration of the first object to D2;
and/or
the determining duration of a first object includes one of the following:
determining that the duration of the first object is duration greater than or equal to the AN PSDB;
determining that the duration of the first object is greater than or equal to the first duration of the first timer;
determining that the duration of the first object is greater than or equal to the sum of the first interval duration and D2;
determining that the duration of the first object is greater than or equal to the sum of the first interval duration and D4;
determining that the duration of the first object is greater than or equal to the sum of the AN PSDB and D2; or
determining that the duration of the first object is greater than or equal to the sum of the first duration of the first timer and D2;
where D1 is one of the following: the PDB, the first duration, duration greater than the PDB, or duration greater than the first duration;
D2 is one of the following: the AN PDB, the second duration, duration greater than the AN PDB, or duration greater than the second duration;
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
where
that the first requirement is met is one of the following: being greater than the PDB/the first duration, or being equal to the PDB/the first duration; and
that the second requirement is met is one of the following: being greater than the AN PDB/the second duration, or being equal to the AN PDB/the second duration;
where the first interval duration includes one of the following:
interval duration between the arrival time of the last packet in the first packet set and the arrival time of the 1st packet in the first packet set; or
interval duration between a time at which the last packet in the first packet set is determined to be lost and the arrival time of the 1st packet in the first packet set;
the PDB/the first duration is short for “the PDB or the first duration”; and
the AN PDB/the second duration is short for “the AN PDB or the second duration”.

In an implementation, in a case that the first object is the first timer of the first packet set, a value of the first object may be greater than or equal to one of the following: a value of the AN PSDB, the sum of the first interval duration and D2, the sum of the first interval duration and D4, or the sum of the AN PSDB and D2.

In an implementation, in a case that the first object is the access network delay budget of the first packet set, a value of the first object may be equal to one of the following: a value of the AN PSDB, the sum of the first interval duration and D2, the sum of the first interval duration and D4, or the sum of the AN PSDB and D2.

Optionally, the apparatus further includes:
a fourth processing module, configured to: in a case that a first condition is met, determine that the delay budget of the first packet set is the PSDB;
where the first condition includes at least one of the following:
when the last packet in the first packet set is received, the remaining duration of the delay budget of the first packet set meets the first requirement;
when the last packet in the first packet set is determined to be lost, the remaining duration of the delay budget of the first packet set meets the first requirement; or
when the last packet in the first packet set is determined to be lost, remaining duration of the delay budget of the last arriving packet in the first packet set meets the first requirement;
where
that the first requirement is met is one of the following: being greater than the PDB/the first duration, or being equal to the PDB/the first duration;
the remaining duration of the delay budget of the last arriving packet is duration obtained by subtracting T1 from a timeout time of the delay budget of the first packet set;
T1 is interval duration between an arrival time of the last arriving packet in the first packet set and an arrival time of the first arriving packet in the first packet set; and
the PDB/the first duration is short for “the PDB or the first duration”.

In an implementation, the timeout time of the delay budget is a time at which timing of the delay budget ends.

Optionally, the apparatus further includes:
a fifth processing module, configured to: in a case that a second condition is met, determine the delay budget of the first packet set;
and/or
in a case that a second condition is met, determine that the delay budget of the first packet set is greater than or equal to the sum of the first interval duration and D1;
and/or
in a case that a second condition is met, modify the remaining duration of the delay budget of the first packet set to D1, and/or restart timing of the delay budget of the first packet set, and set the duration of the delay budget of the first packet set to D1;
where the second condition includes at least one of the following:
when a fourth packet or the last packet in the first packet set is received, the remaining duration of the delay budget of the first packet set is less than the PDB/the first duration;
when the last packet in the first packet set is determined to be lost, the remaining duration of the delay budget of the first packet set is less than the PDB/the first duration;
when the last packet in the first packet set is determined to be lost, remaining duration of the delay budget of the last arriving packet in the first packet set is less than the PDB/the first duration;
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
where a value of the first threshold is a non-zero value that approaches zero;
the PDB/the first duration is short for “the PDB or the first duration”; and
the fourth packet is a packet other than the last packet in the first packet set.

Optionally, in a case that the second condition includes “the remaining duration of the delay budget of the first packet set is less than the PDB/the first duration”, the second condition further includes: the delay budget of the first packet set does not time out;
and/or
in a case that the second condition includes “when the last packet in the first packet set is determined to be lost, the remaining duration of the delay budget of the first packet set is less than the PDB/the first duration”, the second condition further includes: a packet in the first packet set exists in a cache of the first communication device;
where the PDB/the first duration is short for “the PDB or the first duration”.

Optionally, the apparatus further includes:
a sixth processing module, configured to: in a case that a third condition is met, determine that the duration of the first object is a value greater than or equal to the AN PSDB, or determine that the duration of the first object is greater than or equal to the first duration of the first timer;
where the third condition includes at least one of the following:
when the last packet in the first packet set is received, the remaining duration of the first object meets the second requirement;
when the last packet in the first packet set is determined to be lost, the remaining duration of the first object meets the second requirement; or
when the last packet in the first packet set is determined to be lost, remaining duration of the second access network delay budget or the second timer of the last arriving packet in the first packet set meets the second requirement;
where that the second requirement is met is one of the following: being greater than the AN PDB/the second duration, or being equal to the AN PDB/the second duration; and
the AN PDB/the second duration is short for “the AN PDB or the second duration”.

In an implementation, the remaining duration of the second access network delay budget or the second timer of the last arriving packet is one of the following:
interval duration between a current time and a timeout time of the second access network delay budget or the second timer (the timeout time is after the current time, and the current time is a time for determining the remaining duration); or
duration obtained by subtracting an elapsed time from duration of the second access network delay budget or the second timer.

For example, the duration of the second access network delay budget or the second timer is 10 s, and 6 s has elapsed since timing starts. In this case, the remaining duration is 4 s.

In an implementation, the second access network delay budget is, for example, the AN PDB.

Optionally, the apparatus further includes:
a seventh processing module, configured to: in a case that a fourth condition is met, determine the duration of the first object;
and/or
in a case that a fourth condition is met, determine that the duration of the first object is greater than or equal to the sum of the first interval duration and D2;
and/or
in a case that a fourth condition is met, modify the remaining duration of the first object to D2, or restart the first object, and set the duration of the first object to D2;
where the fourth condition includes at least one of the following:
when a fourth packet or the last packet in the first packet set is received, the remaining duration of the first object is less than the AN PDB/the second duration;
when the last packet in the first packet set is determined to be lost, the remaining duration of the first object is less than the AN PDB/the second duration;
when the last packet in the first packet set is determined to be lost, remaining duration of a second object of the last arriving packet in the first packet set is less than the AN PDB/the second duration;
the first object times out, or the remaining duration of the first object reaches a first threshold;
when the first object times out, the last packet in the first packet set is not received, or the last packet in the first packet set is not determined to be lost; or
when the remaining duration of the first object reaches the first threshold, the last packet in the first packet set is not received, or the last packet in the first packet set is not determined to be lost;
where
a value of the first threshold is a non-zero value that approaches zero;
the second object includes one of the following: the second timer or the second access network delay budget;
the AN PDB/the second duration is short for “the AN PDB or the second duration”; and
the fourth packet is a packet other than the last packet in the first packet set.

In an implementation, the second access network delay budget is, for example, the AN PDB.

Optionally, in a case that the fourth condition includes “the remaining duration of a delay budget of the first object is less than the AN PDB/the second duration”, the fourth condition further includes: the delay budget of the first object does not time out;
and/or
in a case that the fourth condition includes “when the last packet in the first packet set is determined to be lost, the remaining duration of a delay budget of the first object is less than the AN PDB/the second duration”, the fourth condition further includes: a packet in the first packet set exists in a cache of the first communication device;
where the AN PDB/the second duration is short for “the AN PDB or the second duration”.

Optionally, the apparatus further includes:
an eighth processing module, configured to: in a case that a fifth condition is met, determine that the delay budget of the first packet set is greater than or equal to the sum of the first interval duration and D3;
and/or
in a case that a fifth condition is met, modify the remaining duration of the delay budget of the first packet set to D3, and/or restart timing of the delay budget of the first packet set, and set the duration of the delay budget of the first packet set to D3;
and/or
in a case that a fifth condition is met, extend the remaining duration of the delay budget of the first packet set;
where the fifth condition includes at least one of the following:
when the last packet in the first packet set is determined to be lost, remaining duration of the delay budget of the last arriving packet in the first packet set is less than the PDB/the first duration; or
when the last packet in the first packet set is determined to be lost, duration obtained by subtracting T1 from a timeout time of the delay budget of the first packet set is less than the PDB/the first duration;
where
T1 is interval duration between an arrival time of the last arriving packet in the first packet set and an arrival time of the first arriving packet in the first packet set;
where
D3 or the extended remaining duration of the delay budget of the first packet set meets the following condition: enabling the delay budget of the last arriving packet in the first packet set to meet the first requirement;
that the first requirement is met is one of the following: being greater than the PDB/the first duration, or being equal to the PDB/the first duration; and
the PDB/the first duration is short for “the PDB or the first duration”.

In an implementation, the fifth condition further includes: the delay budget of the first packet set does not time out.

The delay budget of the last arriving packet is duration obtained by subtracting T2 from the timeout time of the delay budget of the first packet set, and T2 is the arrival time of the last arriving packet in the first packet set.

In an implementation, D3 is shown in FIG. 7.

In an implementation, D3 is less than the PDB/the first duration.

Optionally, the apparatus further includes:
a ninth processing module, configured to: in a case that a sixth condition is met, modify the remaining duration of the first object to D4, and/or restart timing of the first object, and set the duration of the first object to D4;
and/or
in a case that a sixth condition is met, extend the remaining duration of the first object, and/or restart timing of the first object;
where the sixth condition includes one of the following:
when the last packet in the first packet set is determined to be lost, remaining duration of the delay budget of the last arriving packet in the first packet set is less than the AN PDB/the second duration; or
when the last packet in the first packet set is determined to be lost, duration obtained by subtracting T1 from a timeout time of the delay budget of the first packet set is less than the AN PDB/the second duration;
where
T1 is interval duration between an arrival time of the last arriving packet in the first packet set and an arrival time of the first arriving packet in the first packet set;
where
D4 or the extended remaining duration of the first object meets one of the following conditions: enabling the delay budget of the last arriving packet in the first packet set to meet the first requirement, or enabling the second access network delay budget or the second timer of the last arriving packet in the first packet set to meet the second requirement;
where
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget is, for example, the AN PDB.

In an implementation, the sixth condition further includes: the first object does not time out.

For the last arriving packet, the second access network delay budget of the packet is duration obtained by subtracting T2 from the timeout time of the first object, and T2 is the arrival time of the last arriving packet in the first packet set.

In an implementation, D4 is shown in FIG. 7.

Optionally, the apparatus further includes:
a tenth processing module, configured to: in a case that a seventh condition is met, determine that the delay budget of the first packet set is greater than or equal to the sum of the PSDB and D1;
where the seventh condition includes at least one of the following:
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
where
a value of the first threshold is a non-zero value that approaches zero.

Optionally, the apparatus further includes:
an eleventh processing module, configured to: in a case that an eighth condition is met, determine that the duration of the first object is one of the following: greater than or equal to the sum of the AN PSDB and D2, or greater than or equal to the sum of the first duration of the first timer and D2;
where the eighth condition includes at least one of the following:
the first object times out, or the remaining duration of the first object reaches a first threshold;
when the first object times out, the last packet in the first packet set is not received, or the last packet in the first packet set is not determined to be lost; or
when the remaining duration of the first object reaches the first threshold, the last packet in the first packet set is not received, or the last packet in the first packet set is not determined to be lost;
where
a value of the first threshold is a non-zero value that approaches zero.

Optionally, the stopping timing of the delay budget of the first packet set includes:
in a case that a ninth condition is met, stopping timing of the delay budget of the first packet set;
where the ninth condition includes at least one of the following:
all packets in the first packet set are determined to be sent, or the last packet in the first packet set is determined to be lost;
a packet in the first packet set does not exist in a cache;
the delay budget of the first packet set does not time out;
the first object does not time out; or
a delay budget of the last received packet in the first packet set meets a first requirement;
where
that the first requirement is met is one of the following: being greater than the PDB/the first duration, or being equal to the PDB/the first duration; and
the PDB/the first duration is short for “the PDB or the first duration”.

Optionally, the stopping timing of the first object includes:
in a case that a tenth condition is met, stopping timing of the first object;
where the tenth condition includes at least one of the following:
all packets in the first packet set are determined to be sent, or the last packet in the first packet set is determined to be lost;
a packet in the first packet set does not exist in a cache;
the first object does not time out; or
a second access network delay budget or a second timer of the last received packet in the first packet set meets a second requirement;
where
that the second requirement is met is one of the following: being greater than the AN PDB/the second duration, or being equal to the AN PDB/the second duration; and
the AN PDB/the second duration is short for “the AN PDB or the second duration”.

In an implementation, the second access network delay budget is, for example, the AN PDB.

Optionally, the first packet includes a packet that is in the first packet set and that meets a nineteenth condition;
where the nineteenth condition includes at least one of the following:
a packet arrives within a first time interval;
a packet arrives between a start time of timing of the first object and a timeout time of the first object; or
a packet has a second interval duration less than or equal to one of the following: the access network delay budget of the first data set, the delay budget of the first packet set, or duration of the first timer;
a difference obtained by subtracting the second interval duration from the delay budget of the first packet set meets a first requirement;
a difference obtained by subtracting the second interval duration from the duration of the first object meets a second requirement;
when the packet arrives, the delay budget of the first packet set meets the first requirement; and
when the packet arrives, the remaining duration of the first object meets the second requirement;
where
that the first requirement is met is one of the following: being greater than the PDB/the first duration, or being equal to the PDB/the first duration; and
that the second requirement is met is one of the following: being greater than the AN PDB/the second duration, or being equal to the AN PDB/the second duration;
where
the second interval duration is interval duration between an arrival time of the packet and the arrival time of the 1st packet;
the PDB/the first duration is short for “the PDB or the first duration”; and
the AN PDB/the second duration is short for “the AN PDB or the second duration”. In an implementation, the start time of timing is a time at which timing starts.

In an implementation, the timeout time is a time at which timing ends (stops).

In an implementation, if a packet arrives after the first time interval (for example, a time interval of the first PSDB shown in FIG. 10), scheduling is performed based on the PDB, that is, the PSDB is not guaranteed. The PSDB is guaranteed only for a packet arriving within an initial PSDB interval.

In an implementation, the packet arriving between the start time of timing of the first object and the timeout time of the first object includes a packet whose second interval duration is less than or equal to one of the following: the access network delay budget of the first data set, the delay budget of the first packet set, or the duration of the first timer.

In an implementation, an arrival time of a packet may also be referred to as a receiving time of the packet. For example, the second interval duration may also be referred to as interval duration between the receiving time of the packet and the receiving time of the 1st packet. Subsequent descriptions are similar, and are not described again.

Optionally, the second packet includes a packet that is in the first packet set and that meets a twentieth condition;
where the twentieth condition includes at least one of the following:
a packet arrives after a first time interval;
a packet arrives after a timeout time of the delay budget, a timeout time of the access network delay budget, or an expiry time of the first timer of the first packet set; or
a packet has a second interval duration greater than or equal to one of the following: the access network delay budget of the first data set, the delay budget of the first packet set, or duration of the first timer;
a difference obtained by subtracting the second interval duration from the delay budget of the first packet set is less than the PDB/the first duration;
a difference obtained by subtracting the second interval duration from the duration of the first object is less than the AN PDB/the second duration;
when the packet arrives, the delay budget of the first packet set is less than the PDB/the first duration; and
when the packet arrives, the remaining duration of the first object is less than the AN PDB/the second duration;
where
the second interval duration is interval duration between an arrival time of the packet and the arrival time of the 1st packet;
the PDB/the first duration is short for “the PDB or the first duration”; and
the AN PDB/the second duration is short for “the AN PDB or the second duration”.

In an implementation, a packet arriving after the timeout time of the delay budget, the timeout time of the access network delay budget, or the expiry time of the first timer of the first packet set includes a packet whose second interval duration is greater than or equal to one of the following: the access network delay budget of the first data set, the delay budget of the first packet set, or the duration of the first timer.

In an implementation, the twentieth condition further includes: allowing not to discard the packet (for example, allowing to transmit the packet).

In another implementation, a packet arrives after the first time interval (for example, a packet arrives after the timeout time of the third PSDB shown in FIG. 10) is scheduled based on the PDB, that is, the PSDB is not guaranteed. The PSDB is guaranteed only for a packet arriving in an extension interval (for example, a time interval from the timeout time of the first PSDB to the timeout time of the third PSDB shown in FIG. 10).

Optionally, the first time interval is a time interval between a start time of the first time interval and an end time of the first time interval; and
the start time of the first time interval is based on one of the following: the arrival time of the 1st packet in the first packet set, a time at which timing of the delay budget the first packet set starts, a time at which timing of the access network delay budget of the first packet set starts, or a time at which timing of the first timer of the first packet set starts;
and/or
the end time of the first time interval is based on one of the following: a time at which the delay budget of the first packet set times out, a time at which the access network delay budget of the first packet set times out, or a time at which the first timer of the first packet set expires, or a third time;
and/or
duration of the first time interval is one of the following:
the PSDB;
a difference obtained by subtracting the PDB/the first duration from the PSDB;
the sum of the PSDB and the PDB;
the sum of the PSDB and the first duration;
the AN PSDB;
a difference obtained by subtracting the AN PDB/the second duration from the AN PSDB;
the sum of the AN PSDB and the AN PDB; or
the sum of the AN PSDB and the second duration;
where
the third time meets one of the following:
a time at which the remaining duration of the delay budget of the first packet set is greater than or equal to the PDB/the first duration; or
a time at which the remaining duration of the first object is greater than or equal to the AN PDB/the second duration;
the PDB/the first duration is short for “the PDB or the first duration”; and
the AN PDB/the second duration is short for “the AN PDB or the second duration”.

Optionally, the setting a second access network delay budget or duration of a second timer of a third packet includes at least one of the following:
setting the second access network delay budget or the duration of the second timer to the remaining duration of the first object;
in a case that timing of the first object is restarted, restarting timing of the second access network delay budget or the second timer;
when the third packet is received, in a case that a thirteenth condition is met, setting, by the first communication device, the second access network delay budget or the duration of the second timer of the third packet based on the remaining duration of the first object, or setting the second access network delay budget or the duration of the second timer to the remaining duration of the first object; or
when the third packet is received, in a case that a fourteenth condition is met, setting, by the first communication device, the second access network delay budget or the duration of the second timer of the third packet based on the AN PDB/the second duration, or setting the second access network delay budget or the duration of the second timer to D2;
where
the thirteenth condition includes one of the following: the remaining duration of the delay budget of the first packet set meets a first requirement, remaining duration of the access network delay budget of the first packet set meets a second requirement, or remaining duration of the first timer meets the second requirement;
the fourteenth condition includes one of the following: the remaining duration of the delay budget of the first packet set is less than the PDB/the first duration, the remaining duration of the access network delay budget of the first packet set meets the second requirement, or the remaining duration of the first timer is less than the AN PDB/the second duration;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget or the second timer needs to be greater than or equal to the AN PDB. If the remaining duration of the delay budget of the first packet set is less than the PDB (or the remaining duration of the first object (the first timer of the first packet set or the access network delay budget of the first packet set) is less than the AN PDB) because the packet arrives relatively late, the second timer of the packet is set based on the AN PDB. It is not difficult to understand that in this implementation, a packet arriving before the remaining duration of the delay budget of the first packet set is greater than the PDB (or the remaining duration of the first object (the first timer of the first packet set or the access network delay budget of the first packet set) is greater than the AN PDB) is managed by following the PSDB. A packet arriving when the remaining duration of the delay budget of the first packet set is less than the remaining duration of the PDB is managed by following the PDB instead of the PSDB.

In an implementation, the third packet is one or more packets in the packet set.

In an implementation, the setting, by the first communication device, the duration of the second timer based on the AN PDB/the second duration includes: setting the duration of the second timer to a value greater than the AN PDB/the second duration, or setting the duration of the second timer to a value equal to the AN PDB/the second duration.

In this embodiment of this application, for a specified fixed packet set delay budget, the apparatus may modify the packet set delay budget one or more times, to eliminate a case in which the packet set delay budget is insufficient or the packet set delay budget has timed out when a PDU arrives at the RAN due to an N6 jitter.

The information processing apparatus 1600 provided in this embodiment of this application can implement processes implemented in the method embodiment in FIG. 2, and achieve same technical effects. To avoid repetition, details are not described herein again.

Referring to FIG. 17, FIG. 17 is a schematic diagram of a structure of an information processing apparatus according to an embodiment of this application. The apparatus is applied to a first communication device. As shown in FIG. 17, the information processing 1700 includes:
a second obtaining module 1710, configured to obtain second information, where the second information includes at least one of the following: a PDB, an AN PDB, first duration, second duration, or first duration of a first timer; and
a second processing module 1720, configured to perform a second operation based on the second information, where the second operation includes at least one of the following:
determining a delay budget of a first packet set or duration of the first timer;
determining duration of a first object;
restarting timing of the delay budget of the first packet set;
restarting timing of the first object; or
setting a second access network delay budget or duration of a second timer of a third packet;
where
the third packet is one or more packets in the first packet set;
the first object includes one of the following: a first timer of the first data set or a first access network delay budget of the first data set;
the first timer is a discard timer used per packet set; and
the second timer is a discard timer used per packet.

In an implementation, the second communication device includes but is not limited to a terminal and a RAN network element.

The second communication device receives the second information sent by a fourth communication device.

In an implementation, the first duration of the first timer is used to set initial duration of the first timer.

Optionally, the first duration is duration whose value is greater than or equal to the PDB; and
the second duration is one of the following: duration whose value is greater than or equal to the AN PDB, or initial duration of the second timer.

In an implementation, the initial duration of the first timer is duration when the first timer starts or duration before timing starts.

In an implementation, the initial duration of the second timer is duration when the second timer starts or duration before timing starts.

Optionally, in a case that an eleventh condition is met, timing of the delay budget of the first packet set is restarted, or timing of the first object is restarted, where
the eleventh condition includes:
a packet in the first packet set arrives.

In an implementation, the packet in the first packet set does not include a packet first arriving in the first packet set.

It is not difficult to understand that the delay budget of the first packet set increases as the packet is received. In an implementation, a time interval between arrival of adjacent packets in a same packet set is less than or equal to the PDB.

Optionally, the determining a delay budget of a first packet set or duration of the first timer includes at least one of the following:
determining the delay budget of the first packet set based on the PDB or the first duration; or
determining the duration of the first timer based on a difference between the PDB and a CN PDB or a difference between the first duration and a CN PDB.

Optionally, the determining a delay budget of a first packet set or duration of the first timer includes at least one of the following:
setting initial duration of the delay budget of the first packet set to D1;
setting initial duration of the first timer to one of the following: greater than or equal to the difference between the PDB and the CN PDB, or greater than or equal to the difference between the first duration and the CN PDB;
setting remaining duration of the delay budget of the first packet set to D1; or
restarting timing of the delay budget of the first packet set, and/or setting duration of the delay budget of the first packet set to D1;
where
D1 is one of the following: the PDB, the first duration, duration greater than the PDB, or duration greater than the first duration.

In an implementation, the setting includes modification.

In an implementation, when the 1st packet in the packet set arrives, timing of the delay budget of the first packet set starts. An arrival time of the 1st packet in the packet set is a start time of the delay budget of the first packet set.

Optionally, the setting remaining duration of the delay budget of the first packet set to D1, and restarting timing of the delay budget of the first packet set, and/or setting duration of the delay budget of the first packet set to D1 includes at least one of the following:
when an M1th packet arrives, if the delay budget of the first packet set has timed out, restarting timing of the delay budget of the first packet set, and/or setting the duration of the delay budget of the first packet set to D1; or
when the M1th packet arrives, setting the remaining duration of the delay budget of the first packet set to D1, and restarting timing of the delay budget of the first packet set, and/or setting the duration of the delay budget of the first packet set to D1;
where M1 is one of the following: an integer greater than or equal to 1, or an integer greater than or equal to 2.

In an implementation, when the M1th packet arrives, if the delay budget of the first packet set has timed out, the second communication device restarts timing of the delay budget of the first packet set, and the second communication device may further restart the first timer.

In an implementation, the modifying the remaining duration of the delay budget of the first packet set to the first duration when the M1th packet arrives includes: when the M1th PDU arrives and the remaining duration of the delay budget of the first packet set is not zero, modifying the remaining duration of the delay budget of the first packet set to the first duration.

In an implementation, the M1th packet is a packet in a packet set.

In an implementation, M1 may be predefined or preconfigured as each packet in the first packet set. In this case, as shown in the figure, provided that a packet in the first packet set arrives, the remaining duration of the delay budget of the first packet set is modified to the PDB.

Optionally, the determining duration of a first object includes:
determining the duration of the first object based on the AN PDB or the second duration.

Optionally, the determining duration of a first object includes at least one of the following:
setting initial duration of the first object to D2;
setting remaining duration of the first object to D2; or
restarting timing of the first object, and/or setting the duration of the first object to D2;
where the first object includes one of the following: the first timer of the first data set or the access network delay budget of the first data set;
the first timer is a discard timer used per packet set; and
D2 is one of the following: the AN PDB, the second duration, duration greater than the AN PDB, or duration greater than the second duration.

In an implementation, when the 1st packet in the packet set arrives, timing of the first timer starts.

Optionally, the setting remaining duration of the first object to D2, and restarting timing of the first object, and/or setting the duration of the first object to D2 includes at least one of the following:
when an M2th packet arrives, if the first object has timed out, restarting timing of the first object, and/or setting the duration of the first object to D2; or
when the M2th packet arrives, modifying the remaining duration of the first object to D2, and restarting timing of the first object, and/or setting the duration of the first object to D2;
where M2 is one of the following: an integer greater than or equal to 1, or an integer greater than or equal to 2.

In an implementation, when the M2th packet arrives, if the first timer expires, the second communication device restarts timing of the delay budget of the first packet set, and the second communication device may further restart the first timer.

In an implementation, the modifying the remaining duration of the first timer to the AN PDB/the second duration when the M2th packet arrives includes: when the M2th packet arrives, if the first timer does not expire, modifying the remaining duration of the first timer to the AN PDB/the second duration.

In an implementation, the M2th packet is a packet in a packet set.

Optionally, the apparatus further includes:
a twelfth processing module, configured to: in a case that a twelfth condition is met, perform at least one of the following operations:
setting remaining duration of the delay budget of the first packet set to D1;
restarting timing of the delay budget of the first packet set, and/or setting duration of the delay budget of the first packet set to D1;
setting remaining duration of the first object to D2; or
restarting timing of the first object, and/or setting the duration of the first object to D2;
where
the twelfth condition includes:
an arrival time of an M3th packet is later than a fourth time, where the fourth time is one of the following:
a time at which the remaining duration of the delay budget of the first packet set is less than the PDB/the first duration;
a time at which remaining duration of the first timer is less than the AN PDB or the second duration;
a time at which the delay budget of the first packet set times out; or
a time at which the first object times out;
where M3 is one of the following: an integer greater than or equal to 1, or an integer greater than or equal to 2;
where
D1 is one of the following: the PDB, the first duration, duration greater than the PDB, or duration greater than the first duration;
D2 is one of the following: the AN PDB, the second duration, duration greater than the AN PDB, or duration greater than the second duration; and
the PDB/the first duration is short for “the PDB or the first duration”.

In an implementation, the setting, by the second communication device, the remaining duration of the delay budget of the first packet set to the PDB/the first duration when the M3th packet arrives includes: when the M3th packet arrives and the remaining duration of the delay budget of the first packet set is not zero, modifying the remaining duration of the delay budget of the first packet set to the PDB/the first duration.

In an implementation, the setting, by the second communication device, the remaining duration of the first object to D2 when the M3th packet arrives includes: when the M3th packet arrives, and the first object does not time out, modifying the remaining duration of the first object to D2.

By using the foregoing implementations, it is not difficult to understand, the second communication device is prevented from performing the second operation each time a packet is received, thereby reducing overheads.

Optionally, the setting a second access network delay budget or duration of a second timer of a third packet includes at least one of the following:
setting the second access network delay budget or the duration of the second timer to remaining duration of the first object;
in a case that timing of the first object is restarted, restarting timing of the second access network delay budget or the second timer;
when the third packet is received, in a case that a thirteenth condition is met, setting, by the first communication device, the second access network delay budget or the duration of the second timer of the third packet based on the remaining duration of the first object, or setting the second access network delay budget or the duration of the second timer to the remaining duration of the first object; or
when the third packet is received, in a case that a fourteenth condition is met, setting, by the first communication device, the second access network delay budget or the duration of the second timer of the third packet based on the AN PDB/the second duration, or setting the second access network delay budget or the duration of the second timer to D2;
where
the thirteenth condition includes one of the following: remaining duration of the delay budget of the first packet set meets a first requirement, remaining duration of the access network delay budget of the first packet set meets a second requirement, or remaining duration of the first timer meets the second requirement;
the fourteenth condition includes one of the following: the remaining duration of the delay budget of the first packet set is less than the PDB/the first duration, the remaining duration of the access network delay budget of the first packet set meets the second requirement, or the remaining duration of the first timer is less than the AN PDB/the second duration;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget or the second timer needs to be greater than or equal to the AN PDB. If the remaining duration of the delay budget of the first packet set is less than the PDB (or the remaining duration of the first object (the first timer of the first packet set or the access network delay budget of the first packet set) is less than the AN PDB) because the packet arrives relatively late, the second timer of the packet is set based on the AN PDB. It is not difficult to understand that in this implementation, a packet arriving before the remaining duration of the delay budget of the first packet set is greater than the PDB (or the remaining duration of the first object (the first timer of the first packet set or the access network delay budget of the first packet set) is greater than the AN PDB) is managed by following the PSDB. A packet arriving when the remaining duration of the delay budget of the first packet set is less than the remaining duration of the PDB is managed by following the PDB instead of the PSDB.

In an implementation, the third packet is one or more packets in the packet set.

When receiving a packet, the apparatus can determine an applicable packet set delay budget in a timely manner, to eliminate a case in which the packet set delay budget is insufficient or the packet set delay budget has timed out when a PDU arrives at the RAN due to an N6 jitter.

The information processing 1700 provided in this embodiment of this application can implement processes implemented in the method embodiment in FIG. 3, and achieve same technical effects. To avoid repetition, details are not described herein again.

Referring to FIG. 18, FIG. 18 is a schematic diagram of a structure of an information processing apparatus according to an embodiment of this application. The apparatus is applied to a first communication device. As shown in FIG. 18, the information processing 1800 includes:
a third obtaining module 1810, configured to obtain third information, where the third information includes at least one of the following: a first PSDB, a first AN PSDB, first duration of a first timer, first duration of a second timer, a PDB, an AN PDB, first duration, second duration, a first indication, or a second indication; and
a third processing module 1820, configured to perform a third operation based on the third information, where the third operation includes at least one of the following:
setting initial duration of a delay budget of a first packet set to one of the following: an infinite value or a first value;
setting initial duration of a first object to one of the following: an infinite value or a second value;
modifying remaining duration of the delay budget of the first packet set, and/or restarting timing of the delay budget of the first packet set;
modifying remaining duration of the first object, and/or restarting timing of the first object;
stopping timing of the delay budget of the first packet set;
stopping timing of the first object; or
setting a second access network delay budget or duration of a second timer of a third packet;
where
the first PSDB is used to indicate an infinite value or the first value;
the first AN PSDB or the first duration of the first timer is used to indicate an infinite value or the second value;
the first value or the second value meets the following condition: being long enough for the third communication device to determine that the last packet in the first packet set is lost, or being long enough for the third communication device to receive the last packet in the first packet set;
the third packet is one or more packets in the first packet set;
the first object includes one of the following: a first timer of the first data set or an access network delay budget of the first data set;
the first timer is a discard timer used per packet set; and
the second timer is a discard timer used per packet;
where
the first object includes one of the following: the first timer of the first data set, the access network delay budget of the first data set, the AN PSDB, or the first timer;
where
the first indication is used to indicate at least one of the following:
an initial value of the PSDB or a delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify the remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, at a time point at which the last packet in the first packet set is determined to be lost or at a time point after the time point, if no packet in the first packet set exists in a cache (it indicates that the packet in the first packet set has been sent), the third communication device does not perform any operation.

In an implementation, the first condition further includes at least one of the following:
when the last packet in the first packet set is received, the remaining duration of the delay budget of the first packet set meets the first requirement;
when the last packet in the first packet set is determined to be lost, the remaining duration of the delay budget of the first packet set meets the first requirement; or
when the last packet in the first packet set is determined to be lost, remaining duration of the delay budget of the last arriving packet in the first packet set meets the first requirement;
where
that the first requirement is met is one of the following: being greater than the PDB/the first duration, or being equal to the PDB/the first duration; and
the remaining duration of the delay budget of the last arriving packet is duration obtained by subtracting T1 from a timeout time of the delay budget of the first packet set, and T1 is interval duration between an arrival time of the last arriving packet in the first packet set and an arrival time of the first arriving packet in the first packet set.

In an implementation, the second condition further includes at least one of the following:
when a packet or the last packet in the first packet set is received, the remaining duration of the delay budget of the first packet set is less than the PDB/the first duration;
when the last packet in the first packet set is determined to be lost, the remaining duration of the delay budget of the first packet set is less than the PDB/the first duration;
when the last packet in the first packet set is determined to be lost, remaining duration of the delay budget of the last arriving packet in the first packet set is less than the PDB/the first duration;
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
where a value of the first threshold is a non-zero value that approaches zero.

Optionally, the first duration is duration whose value is greater than or equal to the PDB; and
the second duration is one of the following: duration whose value is greater than or equal to the AN PDB, or initial duration of the second timer.

In an implementation, the initial duration of the first timer is duration when the first timer starts or duration before timing starts.

In an implementation, the initial duration of the second timer is duration when the second timer starts or duration before timing starts.

Optionally, the modifying remaining duration of the delay budget of the first packet set, and/or restarting timing of the delay budget of the first packet set includes at least one of the following:
modifying the remaining duration of the delay budget of the first packet set to the PDB/the first duration;
restarting timing of the delay budget of the first packet set, and setting the duration of the delay budget of the first packet set to the PDB/the first duration;
modifying the remaining duration of the delay budget of the first packet set to D3;
restarting timing of the delay budget of the first packet set, and setting the duration of the delay budget of the first packet set to D3; or
shortening the remaining duration of the delay budget of the first packet set;
and/or
the modifying remaining duration of the first object, and/or restarting timing of the first object includes at least one of the following:
modifying the remaining duration of the first object to the AN PDB/the second duration;
restarting timing of the first object, and setting the duration of the first object to the AN PDB/the second duration;
modifying the remaining duration of the first object to D4;
restarting timing of the first object, and setting the duration of the first object to D4;
or
shortening the remaining duration of the first object;
where
D3 meets the following condition: enabling the delay budget of the last arriving packet in the first packet set to meet the first requirement;
D4 or the shortened remaining duration of the first object meets one of the following conditions: enabling the delay budget of the last arriving packet in the first packet set to meet the first requirement, or enabling the second access network delay budget or the second timer of the last arriving packet in the first packet set to meet the second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

Optionally, in a case that a fifteenth condition is met, at least one of the following operations is performed:
modifying the remaining duration of the delay budget of the first packet set and/or restarting timing of the delay budget of the first packet set based on the PDB/the first duration;
modifying the remaining duration of the first object and/or restarting timing of the first object based on the AN PDB/the second duration;
modifying the remaining duration of the delay budget of the first packet set to the PDB/the first duration;
restarting timing of the delay budget of the first packet set, and setting the duration of the delay budget of the first packet set to D1; or
modifying the remaining duration of the first object to D2, or restarting timing of the first object, and setting the duration of the first object to D2;
where the fifteenth condition includes one of the following:
the last packet in the first packet set arrives; or
the last packet in the first packet set is determined to be lost;
where
D1 is one of the following: the PDB, the first duration, duration greater than the PDB, or duration greater than the first duration; and
D2 is one of the following: the AN PDB, the second duration, duration greater than the AN PDB, or duration greater than the second duration;
where
the PDB/the first duration is short for “the PDB or the first duration”; and
the AN PDB/the second duration is short for “the AN PDB or the second duration”.

In an implementation, in a case that the twelfth condition includes “the last packet in the first packet set is determined to be lost”, the fifth condition further includes: a packet in the first packet set exists in a cache.

In an implementation, in a case that D1 is greater than the PDB or the first duration, D1 is less than an infinite value or the first value.

Optionally, the modifying remaining duration of the delay budget of the first packet set, and/or restarting timing of the delay budget of the first packet set includes:
in a case that a sixteenth condition is met, modifying the remaining duration of the delay budget of the first packet set to D3, and/or restarting timing of the delay budget of the first packet set, and setting the duration of the delay budget of the first packet set to D3;
where the sixteenth condition includes at least one of the following:
the last packet in the first packet set is determined to be lost;
when the last packet in the first packet set is determined to be lost, remaining duration of the delay budget of the last arriving packet in the first packet set is less than the PDB/the first duration;
when the last packet in the first packet set is determined to be lost, the remaining duration of the delay budget of the last arriving packet in the first packet set is less than the PDB/the first duration; or
when the last packet in the first packet set is determined to be lost, duration obtained by subtracting T1 from a timeout time of the delay budget of the first packet set is less than the PDB/the first duration;
where T1 is interval duration between an arrival time of the last arriving packet in the first packet set and an arrival time of the first arriving packet in the first packet set;
where
D3 meets the following condition: enabling the delay budget of the last arriving packet in the first packet set to meet the first requirement; and
the PDB/the first duration is short for “the PDB or the first duration”.

Optionally, the modifying remaining duration of the first object, and/or restarting timing of the first object includes:
in a case that a seventeenth condition is met, modifying the remaining duration of the first object to D4, restarting timing of the first object, and setting the duration of the first object to D4, and/or shortening the remaining duration of the first object;
where the seventeenth condition includes at least one of the following:
the last packet in the first packet set is determined to be lost;
when the last packet in the first packet set is determined to be lost, remaining duration of the delay budget of the last arriving packet in the first packet set is less than the AN PDB/the second duration; or
when the last packet in the first packet set is determined to be lost, duration obtained by subtracting T1 from a timeout time of the delay budget of the first packet set is less than the AN PDB/the second duration;
where
T1 is interval duration between an arrival time of the last arriving packet in the first packet set and an arrival time of the first arriving packet in the first packet set;
D4 or the shortened remaining duration of the first object meets one of the following conditions: enabling the delay budget of the last arriving packet in the first packet set to meet the first requirement, or enabling the second access network delay budget or the second timer of the last arriving packet in the first packet set to meet the second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget is, for example, the AN PDB.

In an implementation, the sixth condition further includes: the first object does not time out.

The delay budget of the last arriving packet is duration obtained by subtracting T2 from a timeout time of the first object, and T2 is an arrival time of the last arriving packet in the first packet set.

In an implementation, D4 is shown in FIG. 7.

Optionally, the stopping timing of the delay budget of the first packet set includes:
in a case that the last packet in the first packet set is determined to be lost and an eighteenth condition is met, stopping, by the third communication device, timing of the delay budget of the first packet set;
where the eighteenth condition includes at least one of the following:
a packet in the first packet set does not exist in a cache;
the delay budget of the first packet set does not time out; or
a delay budget of the last received packet in the first packet set meets the first requirement;
where
that the first requirement is met is one of the following: being greater than the PDB/the first duration, or being equal to the PDB/the first duration; and
the PDB/the first duration is short for “the PDB or the first duration”.

Optionally, the stopping timing of the first object includes:
in a case that a tenth condition is met, stopping timing of the first object;
where the tenth condition includes at least one of the following:
all packets in the first packet set are determined to be sent, or the last packet in the first packet set is determined to be lost;
a packet in the first packet set does not exist in a cache;
the first object does not time out; or
a second access network delay budget or a second timer of the last received packet in the first packet set meets the second requirement;
where
that the second requirement is met is one of the following: being greater than the AN PDB/the second duration, or being equal to the AN PDB/the second duration; and the AN PDB/the second duration is short for “the AN PDB or the second duration”.

In an implementation, the second access network delay budget is, for example, the AN PDB.

Optionally, the setting a second access network delay budget or duration of a second timer of a third packet includes at least one of the following:
setting the second access network delay budget or the duration of the second timer to the remaining duration of the first object;
in a case that timing of the first object is restarted, restarting timing of the second access network delay budget or the second timer;
when the third packet is received, in a case that a thirteenth condition is met, setting, by the first communication device, the second access network delay budget or the duration of the second timer of the third packet based on the remaining duration of the first object, or setting the second access network delay budget or the duration of the second timer to the remaining duration of the first object; or
when the third packet is received, in a case that a fourteenth condition is met, setting, by the first communication device, the second access network delay budget or the duration of the second timer of the third packet based on the AN PDB/the second duration, or setting the second access network delay budget or the duration of the second timer to D2;
where
the thirteenth condition includes one of the following: the remaining duration of the delay budget of the first packet set meets the first requirement, remaining duration of the access network delay budget of the first packet set meets the second requirement, or remaining duration of the first timer meets the second requirement;
the fourteenth condition includes one of the following: the remaining duration of the delay budget of the first packet set is less than the PDB/the first duration, the remaining duration of the access network delay budget of the first packet set meets the second requirement, or the remaining duration of the first timer is less than the AN PDB/the second duration;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the second access network delay budget or the second timer needs to be greater than or equal to the AN PDB. If the remaining duration of the delay budget of the first packet set is less than the PDB (or the remaining duration of the first object (the first timer of the first packet set or the access network delay budget of the first packet set) is less than the AN PDB) because the packet arrives relatively late, the second timer of the packet is set based on the AN PDB. It is not difficult to understand that in this implementation, a packet arriving before the remaining duration of the delay budget of the first packet set is greater than the PDB (or the remaining duration of the first object (the first timer of the first packet set or the access network delay budget of the first packet set) is greater than the AN PDB) is managed by following the PSDB. A packet arriving when the remaining duration of the delay budget of the first packet set is less than the remaining duration of the PDB is managed by following the PDB instead of the PSDB.

In an implementation, the third packet is one or more packets in the packet set.

In this embodiment of this application, for a packet set delay budget whose duration has been set to be excessively long, the apparatus may narrow the packet set delay budget to a sufficient packet set delay budget, to eliminate a case in which the packet set delay budget is insufficient or the packet set delay budget has timed out when a PDU arrives at the RAN due to an N6 jitter.

The information processing 1800 provided in this embodiment of this application can implement processes implemented in the method embodiment in FIG. 4, and achieve same technical effects. To avoid repetition, details are not described herein again.

Referring to FIG. 19, FIG. 19 is a schematic diagram of a structure of an information processing apparatus according to an embodiment of this application. The apparatus is applied to a fourth communication device. As shown in FIG. 19, the information processing 1900 includes: a sending module 1910, configured to send at least one of the following:

a first PSDB or a PSDB, a first AN PSDB or an AN PSDB, a PDB, first duration, an AN PDB, second duration, an initial PSDB, first interval duration, a first time, a second time, first duration of a first timer, first duration of a second timer, a first indication, or a second indication;
where
the first time is an arrival time of the 1st packet in a first packet set;
the second time is an arrival time of the last packet in the first packet set, or a time at which the last packet in the first packet set is determined to be lost; and
the first interval duration is interval duration between the arrival time of the last packet in the first packet set and the arrival time of the 1st packet in the first packet set;
where
the first PSDB is used to indicate an infinite value or a first value;
the first AN PSDB or the first duration of the first timer is used to indicate an infinite value or a second value;
the first value or the second value meets the following condition: being long enough for a third communication device to determine that the last packet in the first packet set is lost, or being long enough for a third communication device to receive the last packet in the first packet set;
the first timer is a discard timer used per packet set; and
the second timer is a discard timer used per packet;
where
a first object includes one of the following: a first timer of the first data set, an access network delay budget of the first data set, the AN PSDB, or the first timer;
where
the first indication is used to indicate at least one of the following:
an initial value of the PSDB or a delay budget of the first packet set is an infinite value or the first value;
in a case that a first condition is met, it is required to modify remaining duration of the PSDB or the delay budget of the first packet set to the PDB or the first duration, or restart timing of the PSDB or the delay budget of the first packet set, and set duration of the PSDB or the delay budget of the first packet set to the PDB or the first duration; or
in a case that a second condition is met, it is required to modify the remaining duration of the PSDB to D3, or restart timing of the PSDB, and set the duration of the PSDB to D3;
where
the second indication is used to indicate at least one of the following:
an initial value of the first object is an infinite value or the second value;
in a case that the second condition is met, it is required to modify remaining duration of the first object to the AN PDB or the second duration, or restart timing of the first object, and set duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
D3 meets the following condition: enabling a delay budget of the last arriving packet in the first packet set to meet a first requirement;
D4 meets one of the following conditions: enabling the delay budget of the last arriving packet in the first packet set to meet the first requirement, or enabling a second access network delay budget or a second timer of the last arriving packet in the first packet set to meet a second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the fourth communication device includes but is not limited to a terminal, a RAN network element, and a CN network element. The fourth communication device may send the foregoing information to at least one of the following: a first communication device, a second communication device, a third communication device, a RAN network element, or a terminal.

In a case that the first communication device, the second communication device, or the third communication device is a RAN network element, the fourth communication device may be a CN network element, or a terminal.

In a case that the first communication device, the second communication device, or the third communication device is a terminal, the fourth communication device may be a CN network element, or a RAN network element.

In an implementation, the fourth communication device performs at least one of the following operations based on at least one of the first PSDB or the PSDB, the first AN PSDB or the AN PSDB, the PDB, the first duration, the AN PDB, the second duration, the initial PSDB, the first interval duration, the first time, the second time, the first duration of the first timer, the first duration of the second timer, the first indication, and the second indication: sending first information to the first communication device, sending second information to the second communication device, or sending third information to the third communication device.

In an implementation, the fourth communication device sends the first PSDB, the first AN PSDB, the first duration of the first timer, the first duration of the second timer, the PDB, the AN PDB, the first duration, the second duration, the first indication, and the second indication to the third communication device,
where
the first PSDB is used to indicate an infinite value or a first value;
the first AN PSDB or the first duration of the first timer is used to indicate an infinite value or a second value; and
the first value or the second value meets the following condition: being long enough for the third communication device to determine that the last packet in the first packet set is lost, or being long enough for the third communication device to receive the last packet in the first packet set;
where
the first indication is used to indicate at least one of the following:
the initial value of the PSDB or the delay budget of the first packet set is an infinite value;
the initial value of the PSDB or the delay budget of the first packet set is the first value;
in a case that the first condition is met, it is required to modify the remaining duration of the PSDB or the delay budget of the first packet set to the PDB or the first duration, or restart timing of the PSDB or the delay budget of the first packet set, and set the duration of the PSDB or the delay budget of the first packet set to the PDB or the first duration; or
in a case that the second condition is met, it is required to modify the remaining duration of the PSDB to D3, or restart timing of the PSDB, and set the duration of the PSDB to D3;
where
the second indication is used to indicate at least one of the following:
the initial value of the first object is an infinite value or the second value;
in a case that the second condition is met, it is required to modify the remaining duration of the first object to the AN PDB or the second duration, or restart timing of the first object, and set the duration of the first object to the AN PDB or the second duration; or
in a case that the second condition is met, it is required to modify the remaining duration of the first object to D4, or restart the first object, and set the duration of the first object to D4;
where
the first condition includes at least one of the following: the last packet in the first packet set is received, or the last packet in the first packet set is determined to be lost; and
the second condition includes: the last packet in the first packet set is determined to be lost;
where
the first object includes one of the following: the first timer of the first data set or the access network delay budget of the first data set;
D3 meets the following condition: enabling the delay budget of the last arriving packet in the first packet set to meet the first requirement;
D4 meets one of the following conditions: enabling the delay budget of the last arriving packet in the first packet set to meet the first requirement, or enabling the second access network delay budget or the second timer of the last arriving packet in the first packet set to meet the second requirement;
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

In an implementation, the first duration that is of the first timer and that is sent by the fourth communication device to the first communication device or the second communication device is used to set the initial duration of the first timer.

Optionally, the first duration is duration whose value is greater than or equal to the PDB; and
the first duration is duration whose value is greater than or equal to the PDB;
and/or
the second duration is one of the following: duration whose value is greater than or equal to the AN PDB, or initial duration of the second timer.

In this embodiment of this application, the apparatus may send the first information to the first communication device, the second information may be sent to the second communication device, and the third information may be sent to the third communication device, so that a receive end device performs a corresponding operation to obtain an applicable packet set delay budget, to eliminate a case in which the packet set delay budget is insufficient or the packet set delay budget has timed out when a PDU arrives at the RAN due to an N6 jitter.

The information processing 1900 provided in this embodiment of this application can implement processes implemented in the method embodiment in FIG. 4, and achieve same technical effects. To avoid repetition, details are not described herein again.

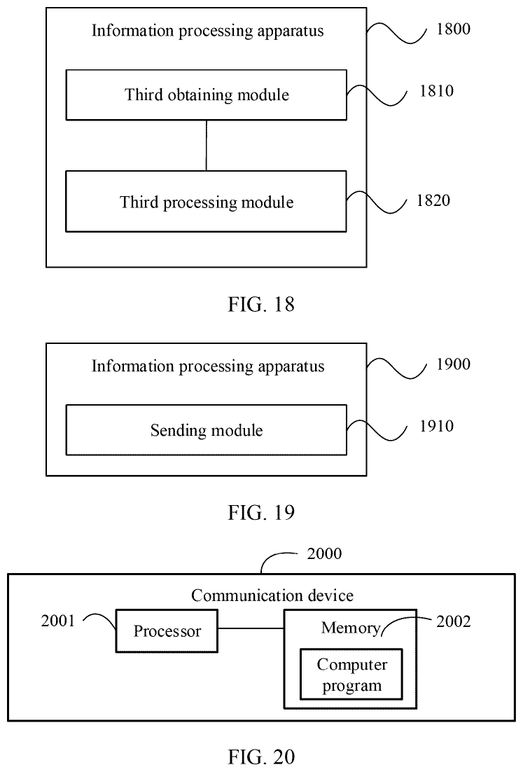

Optionally, as shown in FIG. 20, an embodiment of this application further provides a communication device 2000, including a processor 2001 and a memory 2002. The memory 2002 stores a program or instructions capable of running on the processor 2001. For example, when the communication device 2000 is a first communication device, the program or the instructions is or are executed by the processor 2001 to implement the steps of the information processing method embodiments on the first communication device side, and can achieve the same technical effects. When the communication device 2000 is a second communication device, the program or the instructions is or are executed by the processor 2001 to implement the steps of the information processing method embodiments on the second communication device side, and can achieve the same technical effects. When the communication device 2000 is a third communication device, the program or the instructions is or are executed by the processor 2001 to implement the steps of the information processing method embodiments on the third communication device side, and can achieve the same technical effects. When the communication device 2000 is a fourth communication device, the program or the instructions is or are executed by the processor 2001 to implement the steps of the information processing method embodiments on the fourth communication device side, and can achieve the same technical effects. To avoid repetition, details are not described herein again.

An embodiment of this application further provides a communication device, including a processor and a communication interface. The processor is configured to implement the steps of the methods according to the foregoing aspects.

An embodiment of this application further provides a communication system, including a first communication device, a second communication device, a third communication device, and a fourth communication device. The first communication device may be configured to perform the steps of the information processing method on the first communication device side, the second communication device may be configured to perform the steps of the information processing method on the second communication device side, the third communication device may be configured to perform the steps of the information processing method on the third communication device side, and the fourth communication device may be configured to perform the steps of the information processing method on the fourth communication device side.

An embodiment of this application further provides a readable storage medium. The readable storage medium stores a program or instructions. The program or instructions is or are executed by a processor to implement the processes in the foregoing information processing method embodiments, and the same technical effects can be achieved. To avoid repetition, details are not described herein again.

The processor is a processor in the terminal in the foregoing embodiments. The readable storage medium includes a computer-readable storage medium, such as computer read-only memory ROM, a random access memory RAM, a magnetic disk, or a compact disc.

An embodiment of this application further provides a chip. The chip includes a processor and a communication interface. The communication interface is coupled to the processor. The processor is configured to run a program or instructions, to implement the processes in the foregoing information processing method embodiments, and the same technical effects can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing information processing method embodiments, and the same technical effects can be achieved. To avoid repetition, details are not described herein again.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the prior art may be implemented in a form of a software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners without departing from principles of this application and the protection scope, and all such manners fall within the protection scope of this application.

1. An information processing method, comprising:
obtaining, by a first communication device, first information, wherein the first information comprises at least one of the following: a PDU set delay budget (PSDB), a packet delay budget (PDB), an access network (AN) PSDB, an access network (AN) PDB, first duration, second duration, first interval duration, a first time, a second time, or first duration of a first timer; and
performing, by the first communication device, a first operation based on the first information;
wherein the first operation comprises at least one of the following:
determining a delay budget of a first packet set;
determining duration of a first object;
modifying remaining duration of the delay budget of the first packet set, extending remaining duration of the delay budget of the first packet set, and/or restarting timing of the delay budget of the first packet set;
modifying remaining duration of the first object, extending remaining duration of the first object, and/or restarting timing of the first object;
stopping timing of the delay budget of the first packet set;
stopping timing of the first object;
applying, to a first packet, QoS, a delay, a timer, and/or an operation per packet set;
applying, to a second packet, QoS, a delay, a timer, and/or an operation per packet; or
setting a second access network delay budget or duration of a second timer of a third packet;
wherein
the first packet, the second packet, or the third packet is one or more packets in the first packet set;
the first object comprises one of the following: a first timer of the first data set or an access network delay budget of the first data set, wherein the first timer is a discard timer used per packet set;
the second timer is a discard timer used per packet;
the first time is an arrival time of the 1st packet in the first packet set;
the second time is an arrival time of the last packet in the first packet set; and
the first interval duration is interval duration between the arrival time of the last packet in the first packet set and the arrival time of the 1st packet in the first packet set.

2. The method according to claim 1, wherein
the first duration is duration whose value is greater than or equal to the PDB;
and/or
the second duration is one of the following: duration whose value is greater than or equal to the AN PDB, or initial duration of the second timer;
and/or
the QoS, the delay, the timer, and/or the operation per packet set comprises at least one of the following: the delay budget of the first packet set, the first timer of the first data set, the access network delay budget of the first data set, the PSDB, the AN PSDB, the first timer, scheduling based on the remaining duration of the delay budget of the first data set, or scheduling based on remaining duration of the access network delay budget of the first data set;
and/or
the QoS, the delay, the timer, and/or the operation per packet comprises at least one of the following: the PDB, the AN PDB, the second timer, scheduling based on remaining duration of the PDB, scheduling based on remaining duration of the AN PDB, scheduling based on remaining duration of the packet delay budget, or scheduling based on remaining duration of the second access network delay budget.

3. The method according to claim 1, wherein
the determining a delay budget of a first packet set comprises:
determining the delay budget of the first packet set based on at least one of the PSDB, the PDB, the first interval duration, the first time, the second time, or the first duration;
and/or
the determining duration of a first object comprises:
determining the duration of the first object based on at least one of the AN PSDB, the first duration, the AN PDB, or the second duration;
and/or
the modifying remaining duration of the delay budget of the first packet set, and/or restarting timing of the delay budget of the first packet set comprises:
modifying the remaining duration of the delay budget of the first packet set and/or restarting timing of the delay budget of the first packet set based on the PDB or the first duration;
and/or
the modifying remaining duration of the first object, and/or restarting timing of the first object comprises:
modifying the remaining duration of the first object and/or restarting timing of the first object based on the AN PDB or the second duration.

4. The method according to claim 1, wherein
the determining a delay budget of a first packet set comprises one of the following:
determining that the delay budget of the first packet set is the PSDB;
determining that the delay budget of the first packet set is greater than or equal to the sum of the first interval duration and D1;
determining that the delay budget of the first packet set is greater than or equal to the sum of the first interval duration and D3; or
determining that the delay budget of the first packet set is greater than or equal to the sum of the PSDB and D1;
and/or
the modifying remaining duration of the delay budget of the first packet set, and/or restarting timing of the delay budget of the first packet set comprises at least one of the following:
modifying the remaining duration of the delay budget of the first packet set to D1;
restarting timing of the delay budget of the first packet set, and setting duration of the delay budget of the first packet set to D1;
modifying the remaining duration of the delay budget of the first packet set to D3; or
restarting timing of the delay budget of the first packet set, and setting the duration of the delay budget of the first packet set to D3;
and/or
the modifying remaining duration of the first object, and/or restarting timing of the first object comprises at least one of the following:
modifying the remaining duration of the first object to D4;
restarting timing of the first object, and setting the duration of the first object to D4;
modifying the remaining duration of the first object to D2; or
restarting timing of the first object, and setting the duration of the first object to D2;
and/or
the determining duration of a first object comprises one of the following:
determining that the duration of the first object is duration greater than or equal to the AN PSDB;
determining that the duration of the first object is greater than or equal to the first duration of the first timer;
determining that the duration of the first object is greater than or equal to the sum of the first interval duration and D2;
determining that the duration of the first object is greater than or equal to the sum of the first interval duration and D4;
determining that the duration of the first object is greater than or equal to the sum of the AN PSDB and D2; or
determining that the duration of the first object is greater than or equal to the sum of the first duration of the first timer and D2;
wherein D1 is one of the following: the PDB, the first duration, duration greater than the PDB, or duration greater than the first duration;
D2 is one of the following: the AN PDB, the second duration, duration greater than the AN PDB, or duration greater than the second duration;
D3 meets the following condition: enabling a delay budget of the last arriving packet in the first packet set to meet a first requirement; and
D4 meets one of the following conditions: enabling the delay budget of the last arriving packet in the first packet set to meet the first requirement, or enabling a second access network delay budget or a second timer of the last arriving packet in the first packet set to meet a second requirement;
wherein
that the first requirement is met is one of the following: being greater than the PDB/the first duration, or being equal to the PDB/the first duration; and
that the second requirement is met is one of the following: being greater than the AN PDB/the second duration, or being equal to the AN PDB/the second duration;
wherein the first interval duration comprises one of the following:
interval duration between the arrival time of the last packet in the first packet set and the arrival time of the 1st packet in the first packet set; or
interval duration between a time at which the last packet in the first packet set is determined to be lost and the arrival time of the 1st packet in the first packet set;
the PDB/the first duration is short for “the PDB or the first duration”; and
the AN PDB/the second duration is short for “the AN PDB or the second duration”.

5. The method according to claim 1, further comprising:
in a case that a first condition is met, determining that the delay budget of the first packet set is the PSDB;
wherein the first condition comprises at least one of the following:
when the last packet in the first packet set is received, the remaining duration of the delay budget of the first packet set meets the first requirement;
when the last packet in the first packet set is determined to be lost, the remaining duration of the delay budget of the first packet set meets the first requirement; or
when the last packet in the first packet set is determined to be lost, remaining duration of the delay budget of the last arriving packet in the first packet set meets the first requirement;
wherein
that the first requirement is met is one of the following: being greater than the PDB/the first duration, or being equal to the PDB/the first duration;
the remaining duration of the delay budget of the last arriving packet is duration obtained by subtracting T1 from a timeout time of the delay budget of the first packet set;
T1 is interval duration between an arrival time of the last arriving packet in the first packet set and an arrival time of the first arriving packet in the first packet set; and
the PDB/the first duration is short for “the PDB or the first duration”.

6. The method according to claim 1, further comprising:
in a case that a second condition is met, determining the delay budget of the first packet set;
and/or
in a case that a second condition is met, determining that the delay budget of the first packet set is greater than or equal to the sum of the first interval duration and D1;
and/or
in a case that a second condition is met, modifying the remaining duration of the delay budget of the first packet set to D1, and/or restarting timing of the delay budget of the first packet set, and setting the duration of the delay budget of the first packet set to D1;
wherein the second condition comprises at least one of the following:
when a fourth packet or the last packet in the first packet set is received, the remaining duration of the delay budget of the first packet set is less than the PDB/the first duration;
when the last packet in the first packet set is determined to be lost, the remaining duration of the delay budget of the first packet set is less than the PDB/the first duration;
when the last packet in the first packet set is determined to be lost, remaining duration of the delay budget of the last arriving packet in the first packet set is less than the PDB/the first duration;
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
wherein a value of the first threshold is a non-zero value that approaches zero;
the PDB/the first duration is short for “the PDB or the first duration”; and
the fourth packet is a packet other than the last packet in the first packet set.

7. The method according to claim 6, wherein
in a case that the second condition comprises “the remaining duration of the delay budget of the first packet set is less than the PDB/the first duration”, the second condition further comprises: the delay budget of the first packet set does not time out;
and/or
in a case that the second condition comprises “when the last packet in the first packet set is determined to be lost, the remaining duration of the delay budget of the first packet set is less than the PDB/the first duration”, the second condition further comprises: a packet in the first packet set exists in a cache of the first communication device;
wherein the PDB/the first duration is short for “the PDB or the first duration”.

8. The method according to claim 1, further comprising:
in a case that a third condition is met, determining that the duration of the first object is a value greater than or equal to the AN PSDB, or determining that the duration of the first object is greater than or equal to the first duration of the first timer;
wherein the third condition comprises at least one of the following:
when the last packet in the first packet set is received, the remaining duration of the first object meets the second requirement;
when the last packet in the first packet set is determined to be lost, the remaining duration of the first object meets the second requirement; or
when the last packet in the first packet set is determined to be lost, remaining duration of the second access network delay budget or the second timer of the last arriving packet in the first packet set meets the second requirement;
wherein that the second requirement is met is one of the following: being greater than the AN PDB/the second duration, or being equal to the AN PDB/the second duration; and
the AN PDB/the second duration is short for “the AN PDB or the second duration”.

9. The method according to claim 1, further comprising:
in a case that a fourth condition is met, determining the duration of the first object;
and/or
in a case that a fourth condition is met, determining that the duration of the first object is greater than or equal to the sum of the first interval duration and D2;
and/or
in a case that a fourth condition is met, modifying the remaining duration of the first object to D2, or restarting the first object, and setting the duration of the first object to D2;
wherein the fourth condition comprises at least one of the following:
when a fourth packet or the last packet in the first packet set is received, the remaining duration of the first object is less than the AN PDB/the second duration;
when the last packet in the first packet set is determined to be lost, the remaining duration of the first object is less than the AN PDB/the second duration;
when the last packet in the first packet set is determined to be lost, remaining duration of a second object of the last arriving packet in the first packet set is less than the AN PDB/the second duration;
the first object times out, or the remaining duration of the first object reaches a first threshold;
when the first object times out, the last packet in the first packet set is not received, or the last packet in the first packet set is not determined to be lost; or
when the remaining duration of the first object reaches the first threshold, the last packet in the first packet set is not received, or the last packet in the first packet set is not determined to be lost;
wherein
a value of the first threshold is a non-zero value that approaches zero;
the second object comprises one of the following: the second timer or the second access network delay budget;
the AN PDB/the second duration is short for “the AN PDB or the second duration”; and
the fourth packet is a packet other than the last packet in the first packet set.

10. The method according to claim 9, wherein
in a case that the fourth condition comprises “the remaining duration of a delay budget of the first object is less than the AN PDB/the second duration”, the fourth condition further comprises: the delay budget of the first object does not time out;
and/or
in a case that the fourth condition comprises “when the last packet in the first packet set is determined to be lost, the remaining duration of a delay budget of the first object is less than the AN PDB/the second duration”, the fourth condition further comprises: a packet in the first packet set exists in a cache of the first communication device;
wherein the AN PDB/the second duration is short for “the AN PDB or the second duration”.

11. The method according to claim 1, further comprising:
in a case that a fifth condition is met, determining that the delay budget of the first packet set is greater than or equal to the sum of the first interval duration and D3;
and/or
in a case that a fifth condition is met, modifying the remaining duration of the delay budget of the first packet set to D3, and/or restarting timing of the delay budget of the first packet set, and setting the duration of the delay budget of the first packet set to D3;
and/or
in a case that a fifth condition is met, extending the remaining duration of the delay budget of the first packet set;
wherein the fifth condition comprises at least one of the following:
when the last packet in the first packet set is determined to be lost, remaining duration of the delay budget of the last arriving packet in the first packet set is less than the PDB/the first duration; or
when the last packet in the first packet set is determined to be lost, duration obtained by subtracting T1 from a timeout time of the delay budget of the first packet set is less than the PDB/the first duration;
wherein
T1 is interval duration between an arrival time of the last arriving packet in the first packet set and an arrival time of the first arriving packet in the first packet set;
wherein
D3 or the extended remaining duration of the delay budget of the first packet set meets the following condition: enabling the delay budget of the last arriving packet in the first packet set to meet the first requirement;
that the first requirement is met is one of the following: being greater than the PDB/the first duration, or being equal to the PDB/the first duration; and
the PDB/the first duration is short for “the PDB or the first duration”.

12. The method according to claim 1, further comprising:
in a case that a sixth condition is met, modifying the remaining duration of the first object to D4, and/or restarting timing of the first object, and setting the duration of the first object to D4;
and/or
in a case that a sixth condition is met, extending the remaining duration of the first object, and/or restarting timing of the first object;
wherein the sixth condition comprises one of the following:
when the last packet in the first packet set is determined to be lost, remaining duration of the delay budget of the last arriving packet in the first packet set is less than the AN PDB/the second duration; or
when the last packet in the first packet set is determined to be lost, duration obtained by subtracting T1 from a timeout time of the delay budget of the first packet set is less than the AN PDB/the second duration;
wherein
T1 is interval duration between an arrival time of the last arriving packet in the first packet set and an arrival time of the first arriving packet in the first packet set;
wherein
D4 or the extended remaining duration of the first object meets one of the following conditions: enabling the delay budget of the last arriving packet in the first packet set to meet the first requirement, or enabling the second access network delay budget or the second timer of the last arriving packet in the first packet set to meet the second requirement;
wherein
that the first requirement is met is one of the following: being greater than the PDB/the first duration, or being equal to the PDB/the first duration;
that the second requirement is met is one of the following: being greater than the AN PDB/the second duration, or being equal to the AN PDB/the second duration;
the PDB/the first duration is short for “the PDB or the first duration”; and
the AN PDB/the second duration is short for “the AN PDB or the second duration”.

13. The method according to claim 1, further comprising:
in a case that a seventh condition is met, determining that the delay budget of the first packet set is greater than or equal to the sum of the PSDB and D1;
wherein the seventh condition comprises at least one of the following:
the delay budget of the first packet set times out, or the remaining duration of the delay budget of the first packet set reaches a first threshold;
when the delay budget of the first packet set times out, the last packet in the first packet set is not received, or the last packet in the first packet set is not determined to be lost; or
when the remaining duration of the delay budget of the first packet set reaches the first threshold, the last packet in the first packet set is not received, or the last packet in the first packet set is not determined to be lost;
wherein
a value of the first threshold is a non-zero value that approaches zero.

14. The method according to claim 1, further comprising:
in a case that an eighth condition is met, determining that the duration of the first object is one of the following: greater than or equal to the sum of the AN PSDB and D2, or greater than or equal to the sum of the first duration of the first timer and D2;
wherein the eighth condition comprises at least one of the following:
the first object times out, or the remaining duration of the first object reaches a first threshold;
when the first object times out, the last packet in the first packet set is not received, or the last packet in the first packet set is not determined to be lost; or
when the remaining duration of the first object reaches the first threshold, the last packet in the first packet set is not received, or the last packet in the first packet set is not determined to be lost;
wherein
a value of the first threshold is a non-zero value that approaches zero.

15. The method according to claim 1, wherein the stopping timing of the delay budget of the first packet set comprises:
in a case that a ninth condition is met, stopping timing of the delay budget of the first packet set;
wherein the ninth condition comprises at least one of the following:
all packets in the first packet set are determined to be sent, or the last packet in the first packet set is determined to be lost;
a packet in the first packet set does not exist in a cache;
the delay budget of the first packet set does not time out;
the first object does not time out; or
a delay budget of the last received packet in the first packet set meets a first requirement;
wherein
that the first requirement is met is one of the following: being greater than the PDB/the first duration, or being equal to the PDB/the first duration; and
the PDB/the first duration is short for “the PDB or the first duration”.

16. The method according to claim 1, wherein the stopping timing of the first object comprises:
in a case that a tenth condition is met, stopping timing of the first object;
wherein the tenth condition comprises at least one of the following:
all packets in the first packet set are determined to be sent, or the last packet in the first packet set is determined to be lost;
a packet in the first packet set does not exist in a cache;
the first object does not time out; or
a second access network delay budget or a second timer of the last received packet in the first packet set meets a second requirement;
wherein
that the second requirement is met is one of the following: being greater than the AN PDB/the second duration, or being equal to the AN PDB/the second duration; and
the AN PDB/the second duration is short for “the AN PDB or the second duration”.

17. The method according to claim 1, wherein the first packet comprises a packet that is in the first packet set and that meets a nineteenth condition;
wherein the nineteenth condition comprises at least one of the following:
a packet arrives within a first time interval;
a packet arrives between a start time of timing of the first object and a timeout time of the first object; or
a packet has a second interval duration less than or equal to one of the following: the access network delay budget of the first data set, the delay budget of the first packet set, or duration of the first timer;
a difference obtained by subtracting the second interval duration from the delay budget of the first packet set meets a first requirement;
a difference obtained by subtracting the second interval duration from the duration of the first object meets a second requirement;
when the packet arrives, the delay budget of the first packet set meets the first requirement; and
when the packet arrives, the remaining duration of the first object meets the second requirement;
wherein
that the first requirement is met is one of the following: being greater than the PDB/the first duration, or being equal to the PDB/the first duration; and
that the second requirement is met is one of the following: being greater than the AN PDB/the second duration, or being equal to the AN PDB/the second duration;
wherein
the second interval duration is interval duration between an arrival time of the packet and the arrival time of the 1st packet;
the PDB/the first duration is short for “the PDB or the first duration”; and
the AN PDB/the second duration is short for “the AN PDB or the second duration”.

18. An information processing method, comprising:
obtaining, by a second communication device, second information, wherein the second information comprises at least one of the following: a PDB, an AN PDB, first duration, second duration, or first duration of a first timer; and
performing, by the second communication device, a second operation based on the second information, wherein the second operation comprises at least one of the following:
determining a delay budget of a first packet set or duration of the first timer;
determining duration of a first object;
restarting timing of the delay budget of the first packet set;
restarting timing of the first object; or
setting a second access network delay budget or duration of a second timer of a third packet;
wherein
the third packet is one or more packets in the first packet set;
the first object comprises one of the following: a first timer of the first data set or a first access network delay budget of the first data set;
the first timer is a discard timer used per packet set; and
the second timer is a discard timer used per packet.

19. The method according to claim 18, wherein
in a case that an eleventh condition is met, timing of the delay budget of the first packet set is restarted, or timing of the first object is restarted, wherein
the eleventh condition comprises:
a packet in the first packet set arrives.

20. A communication device, comprising a processor, a memory, and a computer program stored in the memory and capable of running on the processor, wherein the computer program is executed by the processor to implement steps of an information processing method, the method comprising:
obtaining first information, wherein the first information comprises at least one of the following: a PDU set delay budget (PSDB), a packet delay budget (PDB), an access network (AN) PSDB, an access network (AN) PDB, first duration, second duration, first interval duration, a first time, a second time, or first duration of a first timer; and
performing a first operation based on the first information;
wherein the first operation comprises at least one of the following:
determining a delay budget of a first packet set;
determining duration of a first object;
modifying remaining duration of the delay budget of the first packet set, extending remaining duration of the delay budget of the first packet set, and/or restarting timing of the delay budget of the first packet set;
modifying remaining duration of the first object, extending remaining duration of the first object, and/or restarting timing of the first object;
stopping timing of the delay budget of the first packet set;
stopping timing of the first object;
applying, to a first packet, QoS, a delay, a timer, and/or an operation per packet set;
applying, to a second packet, QoS, a delay, a timer, and/or an operation per packet; or
setting a second access network delay budget or duration of a second timer of a third packet;
wherein
the first packet, the second packet, or the third packet is one or more packets in the first packet set;
the first object comprises one of the following: a first timer of the first data set or an access network delay budget of the first data set, wherein the first timer is a discard timer used per packet set;
the second timer is a discard timer used per packet;
the first time is an arrival time of the 1st packet in the first packet set;
the second time is an arrival time of the last packet in the first packet set; and
the first interval duration is interval duration between the arrival time of the last packet in the first packet set and the arrival time of the 1st packet in the first packet set.
